(19) United States
(12) Patent Application Publication
(10) Pub. No.: US 2008/0298784 A1
(43) Pub. Date: Dec. 4, 2008

(54) Method of Sensing Speed of Electric Motors and Generators

(76) Inventor: Mark Allen Kastner, New Berlin, WI (US)

Correspondence Address: MARK A. KASTNER, 15185 W. SMALL ROAD, NEW BERLIN, WI, 53151, US

(21) Appl. No.: 11/757,703

(22) Filed: Jun. 4, 2007

(51) Int. Cl. H02P 7/29; G01P 3/46; H02P 7/06

(52) U.S. Cl. 388/811; 318/490; 324/177

(57) ABSTRACT

A method and circuit for determining the speed and/or counting the revolutions of brush and commutator motors is described. The method and circuitry detects signals present on the windings of the motor due to commutation that occurs at the brushes and commutator of the motor. This method can be used to simply monitor & indicate the motor speed and revolutions or to form the basis of a motor control.

### BACKGROUND OF INVENTION

Electric motors and electric generators are of nearly or completely the same construction; the main difference is how they are used: a motor produces a mechanical output from an electrical input, while a generator produces an electrical output from a mechanical input. Electric motors and electric generators are collectively referred to as electrical machines. In most cases, a motor will work as a generator and a generator will work as a motor; this is particularly true for DC motors and generators. While the bulk of this document describes the invention and the supporting material with reference to use with DC motors, a person skilled in the art will recognize that both the invention and the supporting material apply equally to electric machines in general, including motors and generators used in both AC and DC applications.

Commutator electric motors and generators use one or more pairs of electrically-conductive brushes sliding on a rotating commutator to conduct electrical current to (in the case of a motor) or from (in the case of a generator) the winding(s) on the rotor. The commutator and brushes also make and break the electrical connections between the power source (for a motor) or load (for a generator) and the rotor windings, and periodically reverse the polarity of these connections as needed to produce torque in one rotational direction only (for a motor) or current flow in one direction only (for a generator). The commutator is physically part of the motor's or generator's rotor, and it rotates with the rest of the rotor. The commutator has multiple electrically-conductive segments which are insulated from one another; each of these segments is electrically connected to one end of one or more of the rotor's windings. The electrical connection between a given brush and a given commutator segment is made and broken (connected and disconnected) as the rotor (including the commutator) rotates past the stationary brushes.

Commutator electric motors and generators are also referred to as “brush-type”, “DC” (direct current), or “mechanically commutated” motors and generators. Throughout this disclosure, these terms are used interchangeably, with the intention of including all motor types containing commutator(s) and/or brushes. Some types of DC motors (such as “universal” or “series wound” motors) may be powered from either a DC (direct current) or AC (alternating current) power source; most other types require a DC power source. Brush-type electric motors are available with numerous winding configurations: series wound, shunt wound, and compound wound motors all have windings on both the rotor (rotating portion) and the stator (stationary portion) of the motor. Permanent magnet motors usually have windings on the rotor and one or more pairs of permanent magnets in place of the stator windings. In most DC motors, the rotor windings are the armature (power producing) windings, while the stator windings or magnets create the magnetic field.

Each of these DC motor types has a unique set of characteristics that make it uniquely suitable for certain applications. For example, series wound (universal) DC motors (which have the rotor and stator windings connected in series via the brushes and commutator) have excellent characteristics for use in AC powered power tools, such as electric drills and saws, and for small appliances. These characteristics include:
1. The ability to run on either AC or DC
2. High Starting Torque
3. Wide speed capability (including higher speeds than other motor types running from AC power)
4. Highest horsepower per pound of single phase AC motors
5. Highest horsepower per dollar of single phase AC motors
6. Reversible by transposing the armature or field leads

Similarly, permanent magnet DC motors have characteristics that make them uniquely qualified for a number of applications, such as portable (battery operated) power tools. These characteristics include:
1. Simple and Reliable Construction
2. High efficiency (can be 10 to 15% more efficient than wound field motors)
3. High Starting Torque
4. Linear speed/torque curve
5. Smaller overall size and weight due to replacing the field coils with magnets (for motors of the same power)
6. Highest Power for Size
7. Can often be completely enclosed due to lower losses
8. Wide Speed Capability
9. Only Require Two Leads
10. Easily reversible (by swapping leads)

Similarly, shut wound and compound wound DC motors have characteristics uniquely qualifying them for some applications.

DC generators generally have windings on both the rotor and the stator. A DC excitation current is usually driven into the stator, while DC power is extracted from the rotor windings (via brushes and a commutator).

The simplest type of DC motor is the permanent magnet motor, since it contains rotor windings but no stator windings. In the interest of clarity, most of the examples and simplified schematics within this disclosure describe the invention as used with/on permanent magnet DC motors. Because of this, the terms “motor” and “rotor” are used somewhat interchangeably when referring to the electrical connections of the motor, and the waveforms that are present on those connections. However, this is not intended to imply that these examples and circuits are applicable to only permanent magnet DC motors. The examples and circuits described herein are intended for use with, and the invention described herein is applicable to, any electric motor or generator containing brushes and commutator(s).

In many circumstances it is beneficial or necessary to measure the rotational speed of the motor or generator; this speed is typically measured in rotations per minute (rpm), or rotations per second (rps); less frequently, it is measured in radians per second. The ability to accurately measure the speed of a motor or generator can provide important advantages in many applications. Examples include:
1. Maximizing the power output of the motor. Since the motor's mechanical output power is the product of torque and rotational speed, it can produce the greatest power when run at some optimum speed. This speed is often the maximum speed that does not cause damage to the motor or its mechanical load.
2. Cutting tools (such as drills bits and saw blades that are driven by electric power tools, often with brushed motors) cut best and last longest when run at an optimum speed (often to prevent damage due to overheating of the tool). This optimum speed is dependent upon numerous factors including the blade size, blade material, the material being cut, feed rate, etc. Accurate motor speed measurement allows the motor speed (and thus the tool speed) to be manually or automatically adjusted to obtain this optimum speed, maximizing productivity while preventing damage to the tool or the material being machined.
3. The speed of a DC motor will change if it's mechanical load changes or if it's incoming voltage changes. Accurately measuring the speed of the motor allows a control circuit to automatically adjust the electrical power delivered to the motor to compensate for these load and line induced speed changes (and thus maintain a constant motor speed). This is sometimes called “governing” the motor speed, and the circuit that does this is thus called an electronic governor.
4. The reliability of some mechanical loads can be greatly enhanced if they are soft-started (if the speed is gradually ramped up by ramping up the electrical power applied to the motor). Accurately sensing motor speed can allow the motor to be soft-started at a known rate, regardless of variations in load. Motor speed sensing can be particularly useful for soft starting loads when the load has a large amount of static friction and consequently more torque is required to start the load moving than to subsequently keep the load in motion and accelerate it. Soft start controllers without speed sensing are not as effective for these loads, because the motor and load rapidly accelerate after the static friction has been overcome. A soft start controller with motor speed sensing can sense the sudden speed change that occurs once the static friction has been overcome, and thus immediately reduce the voltage to the motor such that the motor and load accelerate in a steady, gentle fashion.
5. Soft-starting can also be useful in hand-held power tools, such as drills. By ramping the speed of the motor up at a known rate, the torque experienced by the tool's user can be controlled to minimize fatigue and potential injury, while allowing greater control of the tool. Accurately sensing motor speed can allow the increase in motor voltage to be optimized such that the motor speed increase is at a known, desired rate.

In the past it has not been practical to measure the speed of small DC motors used in inexpensive consumer applications (such as power tools, kitchen appliances, etc.) because measuring the motor speed accurately required the addition of a relatively expensive speed sensor. These speed sensors are typically separate electromechanical or electro-optical components that are not an integral part of the motor. They are usually composed of a rotating element, such as a rotating speed wheel or disk that is attached to the motor's rotor shaft, along with a detector that senses the passing wheel. Numerous technologies are used for these speed sensors; two of the more common types are optical and magnetic. In optical speed sensors, the speed wheel has light and dark areas or holes spaced around its surface, generally near its outer edge. A light source (typically a light emitting diode) illuminates one side of the speed wheel/disk to provide reflected light (in the case of a wheel with light & dark areas) or transmitted light (in the case of a wheel with holes). An optical detector (such as a photo-transistor, photo-diode, or photo-resistor) is physically located in a position to sense the resulting variations in reflected or transmitted light, and therefore generates a periodic waveform that is proportional to motor speed. In magnetic speed sensors, the speed wheel has magnetized and un-magnetized areas, or areas magnetized alternately north and south, spaced around its surface, again generally near its outer edge. A coil or Hall sensor is then physically located near the speed wheel such that it can detect the changing magnetic field due to passing magnetic poles in the speed wheel.

These speed sensors have numerous disadvantages:
1. A significant cost increase for the motor assembly, due to both the additional components and additional assembly labor. This added cost may not be economically practical, particularly in the case of inexpensive consumer products.
2. Increase in complexity for the overall motor assembly.
3. The need for precise alignment between the speed wheel, light or magnetic field detector, and light source (for optical speed sensors).
4. Mechanical modifications to standard motors that are required in order to mount the speed sensor components.
5. Speed sensor components of different sizes are needed for motors with different physical sizes.
6. Significant decrease in overall motor reliability because of added components.
7. Reliability problems due to contaminants entering the required close physical spacing between the speed wheel and detector (and light source for optical speed sensors). This is of particular concern if the speed sensor components are located within the can of a brushed motor, due to dust generated as the brushes wear.
8. Reliability problems with optical speed sensors if contaminants get on the surface of a reflective speed wheel or plug the holes of a transmissive speed wheel.
9. Potential interference of from the motor's magnetic field (for magnetic speed sensors)
10. Added cost, complexity, and reliability concerns because of the additional electrical connections required to interface to the speed sensor.
11. Increased sensitivity to motor bearing wear due to the close physical spacings required of the motor speed sensor components.
12. Space for the sensor components may not be available within the motor. If so, a protective enclosure and mounting means will probably be required to mount the sensor external to the motor can.

An accurate speed sensor that does not require additional mechanical components, as described in this text, would thus have many advantages.

It some applications it can also be useful to count the number of revolutions that a motor has turned. For example, when a DC motor is used to position some mechanical device (often via a transmission with a large gear reduction ratio), that device can be accurately positioned by counting the number of revolutions that the motor has turned from some previously known position. This is generally done by using a motor that requires a sequenced electrical drive (such as a stepper motor), with an AC motor driven with a complex motor drive circuit (such as a vector drive), or with a brushless-DC motor & motor drive (which is essentially a polyphase AC motor with electronics to convert the available DC power to the needed AC phases). Alternately, a DC motor with an added speed sensor (as described above) or position encoder is sometimes used. All of these solutions are considerably more expensive than a simple brushed-DC motor.

Robotics is one example of a growing application where position sensing by counting drive motor rotations is useful. While most applications for robots to date have been industrial (such as for assembling automobiles), the use of robots for consumer applications is growing and is expected to become a very large market in coming decades. As the market for domestic robots grows, there will be great competitive pressure to reduce their cost. Since robots typically require multiple actuators, and each actuator requires a motor and a means of tracking actuator position, a less expensive means of tracking actuator position would be of great value (particularly if it would allow the use of inexpensive DC motors).

### SUMMARY OF THE INVENTION

One purpose of this invention is a method of sensing the speed of DC motors and generators and/or sensing the rotor position of DC motors and generators and/or sensing the number of revolutions that DC motors and generators have turned, without the need for additional mechanical components or wiring. Timing signals inherently present in the voltage and current waveforms on the brush/rotor terminals and/or the stator terminals of DC motors and generators are instead utilized to determine the speed and/or position and/or total amount of rotation of the motors and generators. A simple and inexpensive circuit is used to detect these pre-existing speed and rotor position indicating signals. Since these signals are present on the motor's existing rotor/brush terminals and/or stator terminals, no additional mechanical hardware (in the form of a speed or rotor position sensor) and no additional wiring are required. This results in a substantial cost savings and a significant reliability enhancement over other motor speed and position sensing techniques.

It is a further object of this invention to describe some of signals that are inherently present on the brush/rotor terminals and/or stator terminals of DC motors and generators, and how they may be used to determine the position and speed of the motor's rotor.

It is a further object of this invention to describe several embodiments of circuitry that can be used to detect the timing and position related signals that are inherently present on the brush/rotor terminals and/or stator terminals of a DC motor or generator.

It is a further object of this invention to describe how the timing and position information present on the brush/rotor terminals and/or stator terminals of a DC motor or generator and the circuitry to detect it can form the basis of an open-loop or closed-loop motor speed control.

### LIST OF FIGURES

1. Simplified schematic of DC motor connected to battery.

2. Simplified schematic of DC motor connected to battery, with motor broken into the equivalent circuit of a voltage source and a series resistance.

3. Simplified mechanical drawing of a DC motor's brushes and commutator.

4. Diagram showing a motor's rotor winding traveling perpendicular to the motor's magnetic field flux.

5. Diagram showing a motor's rotor winding traveling parallel to the motor's magnetic field flux.

6. Waveforms showing DC voltage applied to motor, counter emf generated by the rotor, and rotor current for a simple 2-segment commutator motor.

7. Comparison of counter-emf waveforms for 2 segment commutator and 4 segment commutator motors.

8. Comparison of rotor current waveforms for 2 segment commutator and 4 segment commutator motors.

9. Simplified schematic of DC motor and battery showing current sense resistor.

10. Waveforms of rotor current and current sense resistor voltage.

11. Oscilloscope shot of running DC motor showing motor current, motor voltage, and timing reference signal waveforms.

12. Simplified schematic showing the use of a comparator to detect the commutator events via fluctuations in motor current.

13. Simplified schematic showing the use of two low pass filters with a comparator to detect rotor current signal via fluctuations in motor current.

14. Waveforms of rotor current signal, two filtered versions of rotor current signal at comparator inputs, and comparator output.

15. Simplified schematic showing the use of two low pass filters with a comparator to detect rotor current signal via fluctuations in motor current, with a DC blocking/AC coupling capacitor and biasing circuit to allow for motor current reversal.

16. Waveforms comparing current sense resistor voltage for forward and reverse directions.

17. Waveforms comparing current sense signal for forward and reverse directions after DC blocking/AC coupling capacitor and biasing circuit.

18. Simplified schematic showing the use of a comparator with a voltage reference to detect rotor current signal via fluctuations in motor current.

19. Simplified schematic showing motor current sensing with isolated current sensor.

20. Simplified schematic showing motor current sensing with current transformer.

21. Rotor current and current transformer output waveforms.

22. Simplified schematic showing motor ripple voltage detector used to sense commutator events.

23. Waveforms showing battery voltage, counter emf, rotor current, and motor voltage variation with upstream impedance.

24. Simplified schematic of motor and battery showing motor's rotor and commutator as switched inductance.

25. Simplified schematic of motor and battery including an equivalent circuit for rotor with inductance, series resistance, and parasitic capacitance.

26. Waveform showing ring on rotor voltage at commutation.

27. Oscilloscope shot from running DC motor showing high frequency ring at commutation.

28. Simplified schematic of DC motor and battery with commutation detector and showing source impedance.

29. Rotor voltage waveform showing high frequency ring voltage or “glitch” at commutation.

30. Simplified schematic of DC motor and battery with current sense resistor, showing parasitic inductance of resistor.

31. Waveform showing voltage signal on current sense resistor, with commutation glitch.

32. Simplified schematic of DC motor with current sense resistor, with separate filters to detect the average current and commutation signal.

33. Waveform showing commutation ring and threshold for detection.

34. Simplified schematic of comparator for detecting commutation glitches and one shot multivibrator for de-bouncing the comparator output.

35. Waveforms showing commutation ring, comparator output, and one shot output.

36. Simplified schematic of series wound DC motor with current sense resistor to detect motor speed and/or count motor revolutions.

37. Simplified schematic of shunt wound DC motor with current sense resistor to detect motor speed and/or count motor revolutions.

38. Simplified schematic of compound wound DC motor with current sense resistor to detect motor speed and/or count motor revolutions.

39. Block diagram of motor speed detector with analog and digital display outputs.

40. Block diagram of motor revolution counter with digital display.

41. Block diagram of DC motor with speed sensor/detector and speed controller.

42. PWM waveform used to control DC motor speed.

43. Simplified Schematic of PWM controller controlling DC motor speed.

44. Block diagram of DC motor with microcontroller based speed control.

45. Block diagram of DC motor with user adjustable microcontroller based speed control.

46. Waveforms showing rotor current with and without high speed PWM modulation, high speed PWM modulation signal, and filtered rotor current signal.

47. Waveforms showing rotor current with and without synchronized PWM modulation and synchronized PWM modulation signal.

48. Waveforms showing rotor current with and without low speed PWM modulation and low speed PWM modulation signal.

49. Waveforms showing commutation signal ring, PWM signal ring, and blanking signal.

50. Waveforms showing commutation pulses with missing and false commutation pulses and blanking/detect enable signal.

51. Waveforms showing commutation pulses embedded in noisy signal, with adjustable detection threshold.

52. Block diagram showing the use of a commutation detector with an adjustable detection threshold.

53. Graph showing the relationship of motor speed and motor voltage, with motor load as a parameter.

54. Graph showing the relationship of motor speed and generated counter-emf, including a band of variation.

55. Block diagram of commutation signal detector with fixed detection threshold and adjustable gain amplifier to change the signal amplitude.

56. Block diagram of commutation signal detector with fixed detection threshold, adjustable gain amplifier, and automatic gain control circuit to adjust the signal amplitude to the needed value.

57. Simplified schematic of microcontroller based motor speed control with commutation detector circuit and windowed commutation signal detection.

58. Waveforms showing different ring frequencies for commutation and PWM caused signals.

59. Simplified schematic showing different parasitic reactive components involved in commutation and PWM caused ringing signals.

60. Block diagram showing the use of a filter to separate commutation glitches from PWM glitches.

61. Block diagram showing the use of a low-pass filter in the power connection to help separate the commutation signal from the PWM signal.

62. Block diagram showing the use of a phase locked loop to develop commutation signal.

63. Diagram of DC motor with commutation based speed sensor and/or motor speed regulator on circuit board within motor.

64. Block diagram of speed sensor/tachometer integrated circuit based on commutation pulse signal monitoring, with connected motor, current sensor, and filters.

65. Block diagram of motor speed control integrated circuit based on commutation pulse signal monitoring, with connected motor, current sensor resistor, and filters.

66. Block diagram of speed sensor/tachometer integrated circuit based on commutation pulse signal monitoring.

67. Block diagram of speed control integrated circuit based on commutation pulse signal monitoring.

68. Full-bridge drive circuit for reversing drive polarity & motor direction.

69. Commutation waveform as the motor slows to a stop, showing increasing period.

70. Flow diagram showing algorithm for slowing motor to a halt using maximum-period threshold detection.

71. Commutation waveform as the motor slows to a stop and then reverses, showing first increasing and then decreasing period.

72. Flow diagram showing algorithm for slowing motor to a halt using motor reversal detection via increasing then decreasing period detection.

73. Motor drive waveform for parking motor.

74. Low-power motor drive waveform for parking motor.

75. Alternate low-power motor drive waveform for parking motor.

### LIST OF ITEMS IDENTIFIED IN DRAWINGS

1. Battery or voltage source.
2. Motor
3. Positive terminal of battery or voltage source.
4. Negative terminal of battery or voltage source.
5. Conductor between power source's positive terminal and motor.
6. Conductor between power source's negative terminal and motor.
7. Equivalent motor resistance.
8. Counter-EMF developed in motor's rotor.
9. Motor's brushes.
10. Motor's commutator.
11. Motor's rotor.
12. Motor's magnetic flux lines
13. North pole of motor's magnetic field.
14. South pole of motor's magnetic field.
15. Portion of motor's rotor conductor with current flowing out of the page.
16. Portion of motor's rotor conductor with current flowing into the page.
17. Motor's rotor shaft.
18. Torque developed by motor's rotor.
19. Force developed by conductor with current flowing out of the page.
20. Force developed by conductor with current flowing into the page.
21. Motor's input voltage waveform.
22. Motor rotor's counter-emf voltage waveform.
23. Motor's rotor current waveform.
24. Counter-emf voltage waveform for two pole rotor.
25. Counter-emf voltage waveform for four pole rotor.
26. Rotor current waveform for two pole rotor.
27. Rotor current waveform for four pole rotor.
28. Current sensing resistor for sensing motor current.
29. Voltage developed by rotor current sensing resistor.
30. Timing reference signal waveform from optical position sensor.
31. Motor input current waveform.
32. Motor input voltage ripple waveform.
33. Comparator used as current sense commutation detector.
34. Non-inverting comparator input.
35. Inverting comparator input.
36. Low pass filter for motor current signal.
37. Average current signal.
38. Current sense detector comparator output signal.
39. Second low pass filter for motor current signal.
40. Second low pass filtered version of motor current signal.
41. Unfiltered current sense signal from current sense resistor.
42. Filtered current sense signal from low-pass filter with higher cutoff frequency.
43. Filtered current sense signal from low-pass filter with lower cutoff frequency.
44. Current sense detector comparator output signal.
45. AC coupling/DC blocking capacitor.
46. Resistor biasing network.
47. Current sense signal at current sense resistor for forward motor direction.
48. Current sense signal at current sense resistor for reverse motor direction.
49. Current sense signal after AC coupling/DC blocking capacitor and resistor biasing network for forward motor direction.
50. Current sense signal after AC coupling/DC blocking capacitor and resistor biasing network for reverse motor direction.
51. Voltage reference.
52. Isolated current sensor.
53. Current transformer.
54. Primary of current sense transformer.
55. Secondary of current sense transformer.
56. Load resistor for current sense transformer.
57. Motor current through primary of current sense transformer.
58. Motor current signal developed at secondary of current sense transformer.
59. Power lead impedance.
60. Voltage ripple detector for detecting commutation events.
61. Supply voltage waveform.
62. Counter-emf waveform.
63. Rotor current waveform.
64. Rotor voltage waveform.
65. Commutator and brushes represented as switches.
66. Inductance of a rotor winding.
67. Series resistance of the rotor winding.
68. Parasitic parallel capacitance of the rotor winding.
69. Resonant LC circuit composed of rotor winding inductance and parasitic parallel capacitance.
70. Ring voltage at breaking of a brush/commutator connection.
71. Ring voltage or “glitch” from commutation.
72. Series impedance of power source and interconnecting wiring.
73. Ring voltage/commutation detector circuit.
74. Regular period of commutation caused ring voltage.
75. Ring voltage.
76. Parasitic inductance of current sense resistor.
77. Current sense waveform on typical running motor, with commutation glitches.
78. Commutation glitch on current sense signal.
79. Low pass filter to detect average current signal.
80. Hi pass filter to detect commutation glitch.
81. Optional band pass filter to detect commutation glitch.
82. Reference voltage.
83. One shot multivibrator as one-shot circuit for de-bouncing commutation signal.
84. Timing components for one-shot multivibrator.
85. Commutation detector.
86. Output waveform from one-shot multivibrator.
87. Multiple cycle commutation ring waveform.
88. Detector comparator output waveform during multiple cycle commutation ring event.
89. One shot multivibrator output waveform during multiple cycle commutation ring event.
90. Commutation event detector.
91. Commutation detector output waveform.
92. Frequency to voltage or frequency to current conversion circuit.
93. Voltage or current signal that is proportional to motor speed.
94. Analog meter to indicate motor speed.
95. Analog to digital converter.
96. Digital output from analog to digital converter.
97. Digital display driver.
98. Digital display to indicate motor speed.
99. Composite analog to digital converter and digital display driver.
100. Digital counter.
101. Output from digital counter.
102. Digital display driver.
103. Digital display.
104. Controllable voltage source.
105. DC motor.
106. Current sensing element.
107. Speed detector.
108. Motor speed signal from speed detector.
109. Command speed signal.
110. Motor speed error signal.
111. Supply voltage.
112. Zero volts.
113. PWM period/frequency.
114. Effective motor drive voltage.
115. PWM (Pulse Width Modulation) Controller.
116. Semiconductor switch.
117. Motor.
118. Supply voltage.
119. Motor.
120. Electronic switch.
121. PWM Controller.
122. Intelligent circuit element.
123. Current sensing element.
124. Motor speed signal.
125. Filter circuitry.
126. Commutation signal detector.
127. Detector output signal.
128. Timer/counter.
129. Digital motor speed signal.
130. Digital reference value.
131. Digital comparison.
132. Speed error signal.
133. Adjustable motor speed reference signal.
134. Analog to digital converter.
135. Potentiometer.
136. Adjustable digital reference value.
137. Rotor current signal.
138. PWM signal used to driver the power switch.
139. Rotor current waveform with PWM modulation.
140. Rotor current waveform with PWM modulation filtered out.
141. Motor current without PWM modulation.
142. PWM signal used to driver the power switch.
143. Motor current with PWM modulation.
144. Motor current without PWM modulation.
145. PWM signal.
146. Motor current with PWM modulation.
147. Voltage ring signals from commutation events.
148. Voltage ring signals from PWM drive transitions.
149. Voltage ring signals from both commutation events and from PWM drive transitions.
150. Blanking signal.
151. Reconstructed commutation pulse waveform, showing regular period of commutation pulses.
152. Blanking or enable/disable signal.
153. True commutation signals.
154. False commutation signals.
155. Missing commutation pulse.
156. Regular Period of Commutation Signals
157. Adjustable commutation detection threshold.
158. True commutation voltage ring signals.
159. Composite signal from motor brushes.
160. Commutation detector.
161. Family of speed vs. voltage curves for various loads.
162. Band of variation of counter-emf vs. motor speed.
163. Fixed threshold signal.
164. Adjustable gain amplifier.
165. Automatic gain control circuit.
166. Motor.
167. Semiconductor switch.
168. Current sensing element.
169. Current sense signal.
170. Low pass filter.
171. Filtered current sense signal.
172. Reference PWM generator.
173. PWM reference signal.
174. Low pass filter.
175. Filtered reference value.
176. Commutation detector.
177. Pulse train signal for motor commutation rate.
178. Blanking circuit.
179. Timer/Counter
180. Digital reference value.
181. Internal digital reference value stored in memory.
182. Analog to digital converter.
183. External speed adjust control.
184. Digital comparison.
185. PWM generator for drive signal.
186. Intelligent device.
187. PWM pulse train drive signal.
188. Blanking signal generator.
189. Blanking signal.
190. Ringing voltage due to commutation.
191. Ringing voltage due to PWM drive.
192. LC tank circuit in rotor.
193. Inductance of the rotor winding.
194. Parasitic capacitance of the rotor winding.
195. LC tank circuit active during PWM switching.
196. Distributed inductance of PWM LC circuit.
197. Distributed capacitance of PWM LC circuit.
198. PWM switch.
199. Rotor.
200. Filter to preferentially pass commutation based ring frequencies.
201. Commutation detector.
202. Low pass filter.
203. PWM power source.
204. Motor.
205. Phase Locked Loop
206. Motor power connections.
207. Motor housing.
208. Motor rotor.
209. Motor stator windings or magnets.
210. Motor brushes.
211. Motor commutator.
212. Motor output shaft.
213. Motor controller circuit board.
214. Bottom conductor layer of circuit board.
215. Circuit board traces.
216. Speed sensor application specific integrated circuit (ASIC).
217. Motor.
218. Current Sensor
219. Filter.
220. Filter.
221. Commutation detector.
222. Pulse train output.
223. Frequency to voltage converter.
224. Linear output.
225. Power conditioning circuitry.
226. Motor controller application specific application specific integrated circuit (ASIC).
227. Motor.
228. Current Sensor
229. Filter.
230. Filter.
231. Commutation detector.
232. Frequency to voltage converter.
233. Subtraction.
234. Speed reference signal.
235. Internal reference.
236. External reference source.
237. Result of subtraction.
238. Pulse width modulator.
239. Semiconductor switch.
240. Power conditioning circuitry.
241. Speed sensor application specific integrated circuit (ASIC).
242. Filter.
243. Filter.
244. AC coupling/DC blocking circuit
245. Biasing Circuit
246. Commutation detector.
247. Pulse train output.
248. Frequency to voltage converter.
249. Linear output.
250. Power conditioning circuitry.
251. Motor controller application specific application specific integrated circuit (ASIC).
252. Filter.
253. Filter.
254. AC coupling/DC blocking circuit
255. Biasing Circuit
256. Commutation detector.
257. Pulse train output.
258. Frequency to voltage converter.
259. Linear output.
260. Power conditioning circuitry.
261. Speed reference signal.
262. Speed error signal.
263. Pulse width modulator.
264. Output amplifier.
265. Power conditioning circuitry.
266. Full bridge circuit.
267. Upper left switch.
268. Lower left switch.
269. Upper right switch.
270. Lower right switch.
271. Battery.
272. Motor.
273. Initial motor direction.
274. Motor power reversal.
275. Commutation period measurement.
276. Determining if minimum period has been reached.
277. Motor drive is stopped.
278. Initial motor direction.
279. Motor power reversal.
280. Commutation period measurement.
281. Determining of minimum period has been reached.
282. Motor drive is stopped.
283. Dead-time intervals in motor drive.
284. Back to back motor drive signals.

### DETAILED DESCRIPTION OF INVENTION, INCLUDING PREFERRED EMBODIMENTS

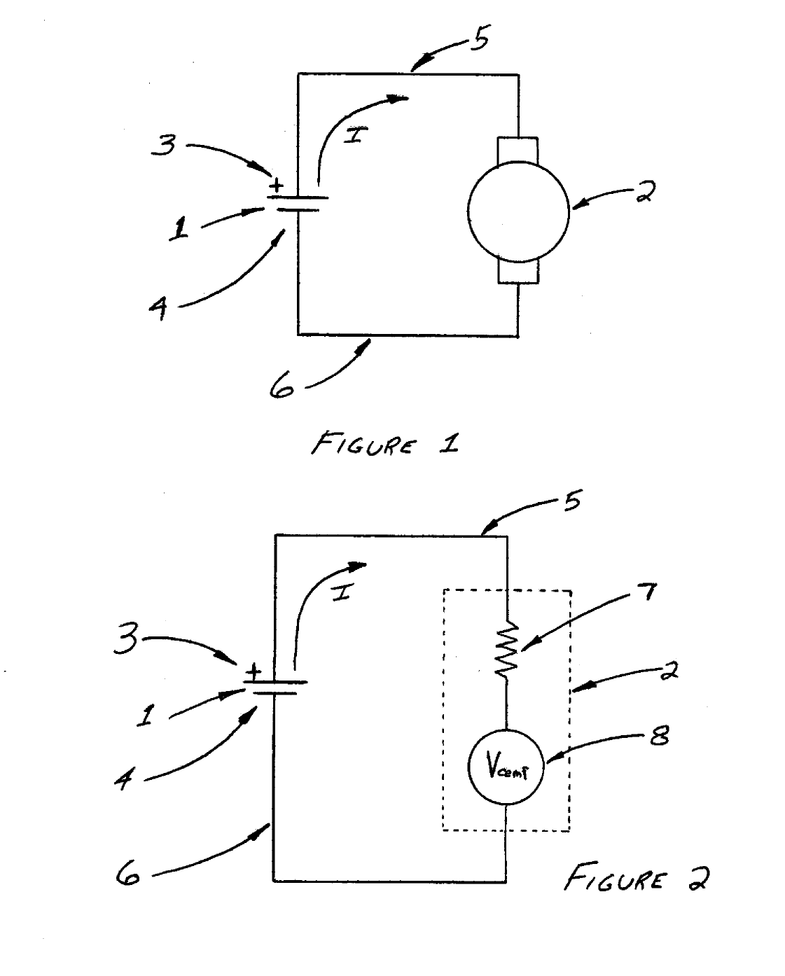

FIG. 1 shows a simplified schematic of a battery (1) powering a DC motor (2). The schematic most accurately portrays a permanent-magnet DC motor, which has rotor windings but no stator windings. However, the motor symbol shown in this schematic may also be used to generically represent any type of DC motor, including the many types that have both rotor windings and stator windings. The motor symbol in FIG. 1 is used in this generic sense in most of the figures contained within this document.

In FIG. 1 and in other figures contained herein, a single-cell battery (1) is shown as the power source for the motor (2). As per common convention, this single-cell battery symbol is used to generically represent batteries of any number of cells or voltage, and also any DC voltage source. Further, within this document, this battery symbol is used to generically represent any DC or AC power source that may be used to power a motor.

In the simplified schematic shown in FIG. 1, the motor voltage is equal to battery voltage; the conductors connecting the battery to the motor are assumed to have zero impedance. Following the positive current-flow convention: current flows from the battery's positive terminal (3), through upper conductor (5), through the motor (2), back through the lower conductor (6) and back to the battery's negative terminal (4).

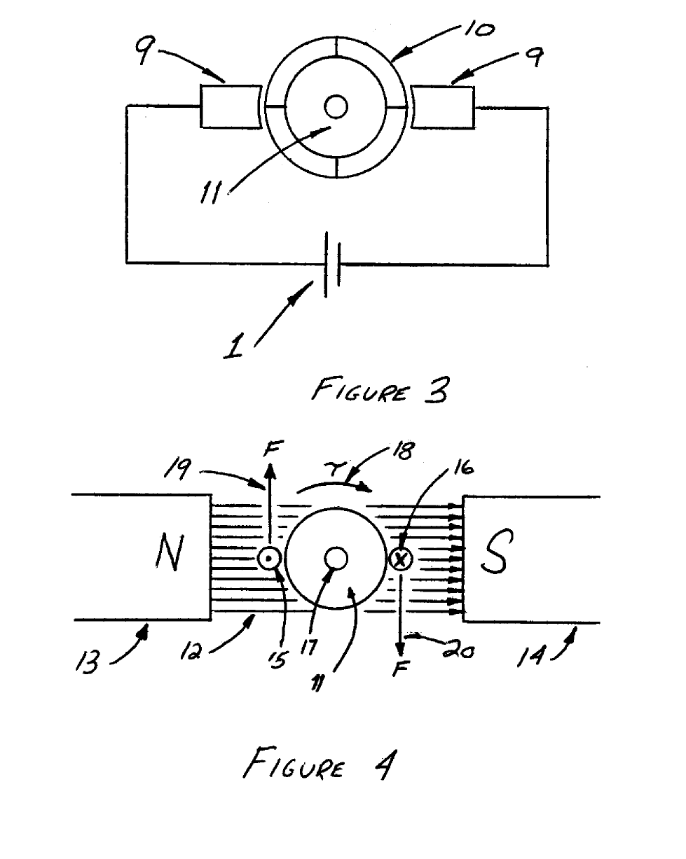

FIG. 2 shows the motor broken down into two components: the equivalent motor resistance (7) and a voltage called counter-emf (electro-motive-force) (8). The equivalent resistance represents the total resistance as seen at the terminals of the motor, which includes the resistance of the rotor winding(s) currently connected to the brushes by the commutator, the commutator, the brushes, the wires connecting the brushes to the terminals, and the terminals themselves. The counter-emf is a voltage that the rotor windings develop as the motor turns, as the rotor windings cut through the motor's magnetic field (which is present due to the permanent magnets or due to current flow in the stator/field windings). The voltage present across the terminals of this counter-emf virtual voltage source (V_{CEMF}) (8) is not the same as the voltage across the entire motor (2) if any current is flowing through the motor (as is normally the case), due to IR drop across the equivalent motor resistance. The current that flows through the rotor of the motor can be calculated if the motor terminal voltage, counter-emf voltage, and rotor resistance is known:

I_{Rotor}=(V_{Terminal}−V_{CEMF})/R_{Rotor}

### Where:

I_{Rotor}=The current through the motor's rotor
V_{Terminal}=The voltage of the power source, seen at the motor's terminals
V_{CEMF}=The counter-emf voltage developed by the motor's rotor
R_{Rotor}=The equivalent resistance of the rotor (including the motor's rotor windings, commutator, brushes, and the interconnecting wiring)

The counter-emf voltage is proportional to the speed of the motor, and is normally opposite in polarity to the voltage applied to the motor's terminals. It is important to note that while the counter-emf behaves in every way like a real voltage source, it cannot be physically separated from the motor's series resistance. Thus, it is not possible to directly measure the counter-emf generated by a motor's rotor when current is flowing in the rotor (as is normally the case for a running motor). Instead, the counter-emf of a running motor's rotor must be calculated from known and directly measurable quantities (rotor terminal voltage, rotor current, and equivalent motor resistance (including the resistance of the commutator, brushes, and connecting wiring).

FIG. 3 shows a simple mechanical representation of a motor's brushes (9), commutator (10), and rotor (11). As the rotor (including the commutator) turns, the connections to a given rotor winding are made (connected) and broken (disconnected) as the connected commutator conductor bar slides past a motor brush. Thus, the rotor windings are connected, disconnected, reconnected in the opposite polarity, and then once again disconnected as the rotor turns.

As previously stated, the counter-emf voltage is proportional to the motor's speed. While this voltage is generally considered to be a constant DC value for a given motor speed, in reality it is periodic waveform.

Counter-emf is developed via generator action. That is, a voltage is developed as the rotor windings pass through the motor's magnetic field. In a permanent magnet (PM) DC motor, the magnetic field is supplied by the magnets; in DC motors with stator windings, current flow in the stator windings supplies the magnetic field. The actual instantaneous counter-emf voltage developed across a given rotor winding is proportional to the speed that the winding passes through or “cuts” through lines of magnetic flux in the magnetic field.

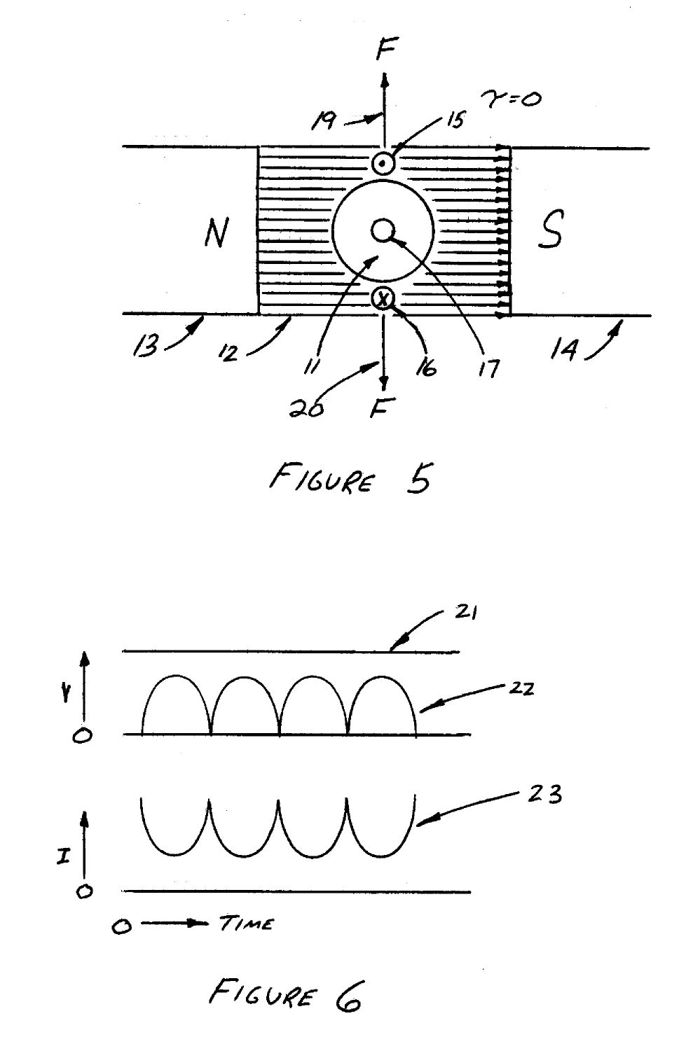

With the rotor turning at a fixed rotational speed, the instantaneous speed that these windings cut through the flux lines in the motor's magnetic field depends on the instantaneous rotational position (angle) of that rotor winding. As shown in FIG. 4, and as per convention, the magnetic field between the motor's field poles causes lines of magnetic flux (12) that flow from the motor field's north pole (13) to the motor field's south pole (14). At a fixed rotational speed, the rotor's windings (15) and (16) pass through the greatest number of lines of the motor's magnetic flux per unit of time when the winding's conductors are traveling perpendicular to the lines of magnetic flux, as shown in FIG. 4. Thus, the greatest counter-emf voltage is developed at this time. When the rotor's windings (15) and (16) are traveling parallel to the motor's magnetic flux lines as shown in FIG. 5, they cut through the minimum number of magnetic flux lines in a given period of time. Thus, the minimum counter-emf voltage is developed at this time. As a result, the counter-emf voltage developed in the rotor windings is a not fixed DC value at a fixed motor speed, but is instead a periodic waveform that varies with the rotor's angular position.

Note that the two conductors of the windings shown in FIGS. 4 and 5 are part of the same winding, which forms a loop. FIGS. 4 and 5 are end-on (axial) views of the motor, as though looking directly into the motor shaft (17). Both conductors are perpendicular to the plane of the page in these figures. Conductor (15) has current flowing directly out of the page, while conductor (16) has current flowing directly into the page. These two conductors are assumed to be connected to complete the loop, below the plane of the page.

Note further that while the magnetic flux passes though these conductors in the same direction (left to right in the drawing), the conductors are traveling in opposite directions through that field: In FIG. 4, conductor (15) is moving upward through the flux, while conductor (16) is moving downward through the flux. Thus, the counter-emf voltage developed by these two conductors is opposite in polarity. Connecting the two conductors in a loop connects the instantaneously positive end of one of these conductors with the instantaneously negative end of the other conductor, such that their voltages add in series. In practice, most rotor windings have many conductors forming many loops that are effectively all connected in series, and all simultaneously passing through the same magnetic field.

It is worth noting that when the instantaneous counter-emf is at its peak (when the conductors are moving perpendicular to the magnetic field, as in FIG. 4), the rotor also produces its peak torque (18). Assuming the magnetic flux is equal throughout the range of motion of the rotor's conductors, the force exerted on those conductors (due to the current flowing in them and the magnetic field) remains constant throughout their range of travel. The force (19) exerted on conductor (15) is upward and of the same magnitude in both FIGS. 4 and 5, while the force (20) exerted on conductor (16) remains downward and of the same magnitude in both FIGS. 4 and 5. When the conductors are in the positions shown in FIG. 4, this force is multiplied by a lever arm of the maximum length, to produce the maximum torque (18) in the motor's rotor shaft. When the conductors are in the positions shown in FIG. 5, the lever arm has zero length, and thus no torque is produced in the motor's rotor shaft.

The actual counter-emf voltage developed by a single rotor winding as it rotates around the rotor shaft is very nearly sinusoidal; variations from an ideal sinusoidal waveform are largely due to the imperfect construction of the motor. The effective resulting counter-emf waveform seen at the motor terminals is a rectified sine wave, due to the rectification performed by the commutator and the brushes (which change the current direction in the rotor windings by changing the polarity of the applied voltage as the rotor turns).

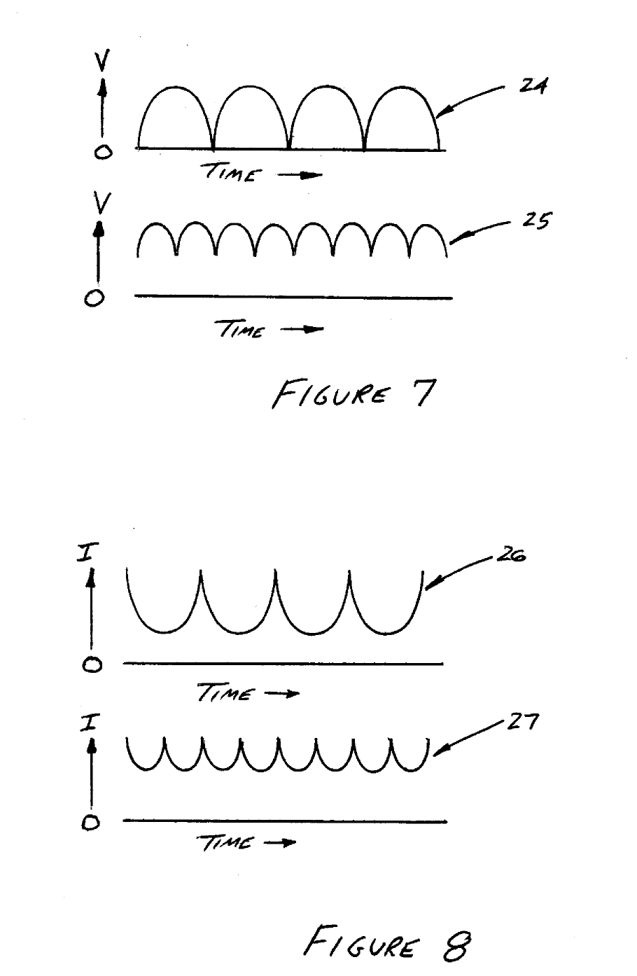

FIG. 6 shows the relationship between the input voltage (21), the counter-emf voltage (22), and the rotor current (23) waveforms for a simple two-pole rotor. The input voltage (21) is assumed to be a fixed DC voltage, as shown in the figure. The counter-emf (22) is a rectified sine wave, for reasons previously discussed. The rotor current (23) follows the formula previously presented, but on a real-time basis. As the rotor turns, the counter-emf voltage (22) varies as angle that the rotor's conductors cut through the magnetic field changes. The net voltage across the relatively fixed rotor resistance (the supply voltage minus the instantaneous counter-emf voltage) varies with the rotor position; this causes the rotor's instantaneous current (23) to vary in similar fashion.

The result is a current waveform with a regular, periodic waveshape. The frequency of this waveform is precisely related to the speed of the motor. In the simplest case of a motor with two brushes and a single rotor winding connected to two commutator bars, the resulting current waveform will have exactly two cycles per motor revolution. Measuring the frequency and/or period of this current waveform will provide precise and timely information about the motor's instantaneous speed. Counting the number of cycles that have passed in a given time interval will provide precise information about the total number of revolutions that the motor has turned in that interval.

As previously discussed, when a rotor winding is traveling parallel to the magnetic field, that winding contributes no torque to the motor's shaft. Thus, a single-winding rotor has torque “dead-spots”: rotational positions (as shown in FIG. 5) where no torque is developed. The rotational inertia of the motor's rotor can be used to carry the rotor through these torque dead-spots, once it is moving. However, if this simple motor stops at one of these dead spots, it may not be possible to restart the motor by simply applying voltage to the motor terminals. In practice, it is far more common for a rotor to include multiple phase-displaced rotor windings, such that at least one of these windings will always develop torque when the motor is energized. DC motors often have many phase-displaced rotor windings connected to many phase-displaced commutator segments.

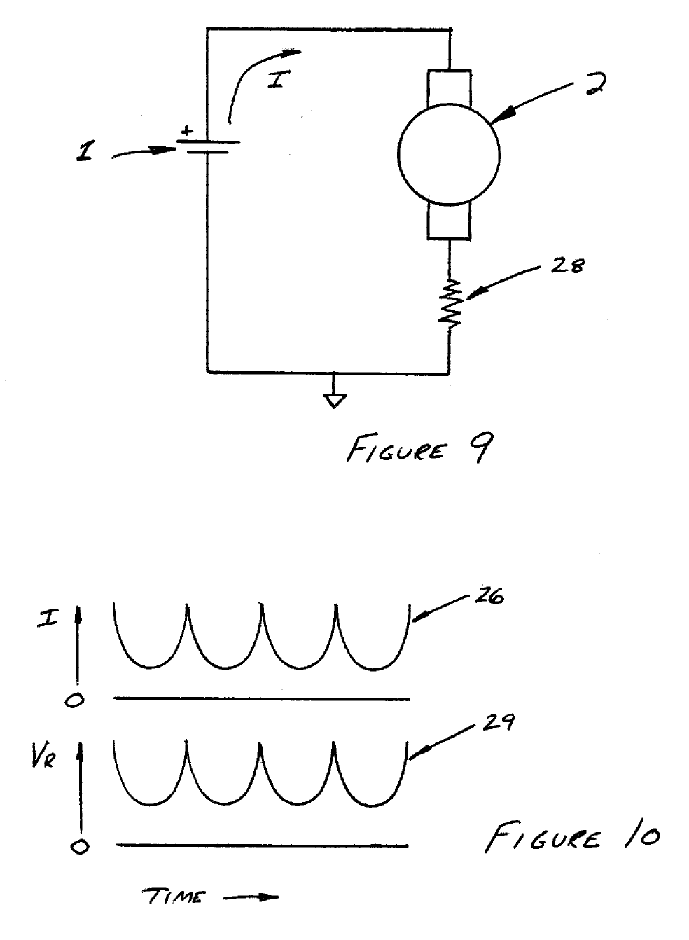

FIG. 7 shows a comparison of the counter-emf waveforms for a two-pole and a four-pole rotor. FIG. 8 shows a comparison of the resulting rotor current waveforms. While the counter-emf developed by the 2-pole rotor (24) goes to zero volts twice during each revolution of the revolving rotor, the counter-emf developed by the 4-pole rotor (25) never goes to zero during the rotor's revolution. In a rotating 4-pole rotor, at least one of the windings is always moving through the magnetic field at something other than a parallel orientation; thus, some counter-emf voltage is always developed. As a result, the counter-emf voltage waveform never goes to zero volts, and the rotor current waveform has a much smaller AC component (ripple voltage). The counter-emf voltage waveform of the 4-pole rotor (25) has twice the frequency and less ripple voltage than the counter-emf voltage waveform for the two-pole rotor (24). Similarly, the rotor current waveform for the 4-pole rotor (27) has twice the frequency and less ripple voltage than the rotor current waveform for the 2-pole rotor (26).

In common practice, motors are made with numerous rotor windings. In general, more individual rotor windings results in:

1. Counter-emf voltage with a proportionally higher AC component (ripple) frequency.
2. Rotor current with a proportionally higher AC component (ripple) frequency.
3. Counter-emf voltage with a lower AC component (ripple) amplitude.
4. Rotor current with a proportionally lower AC component (ripple) amplitude.
. . . at a given load, motor voltage, etc.

Some motors are also made with multiple pairs of brushes. This may have the same effect as the increase in number of rotor windings (as noted above), depending upon their angular spacing and the electrical connections of these brushes and of the rotor windings to the commutator bars. In any case, the resulting AC component frequencies for counter-emf voltage and rotor current will be a fixed multiple of rotor speed, making rotor speed and total rotation measurement inherently very accurate when using the techniques described herein.

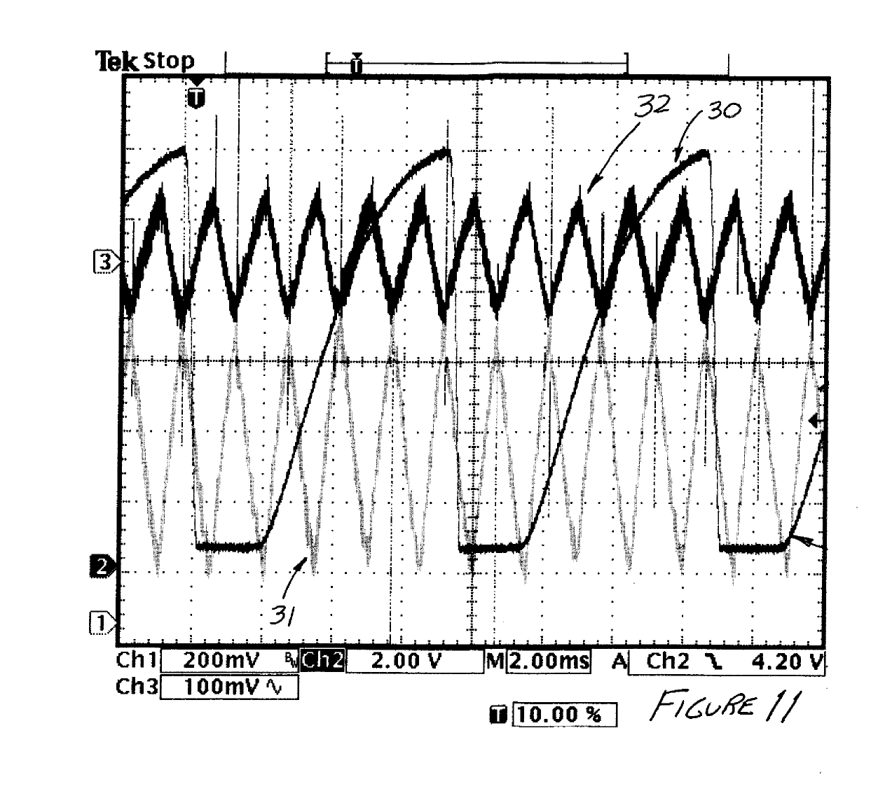

In order to measure the instantaneous rotor speed or to count total rotor rotations based upon the information imbedded in the rotor current waveform, the rotor current must be measured in real time. FIG. 9 shows the simplest method of doing this, which is by inserting a low-value current sensing resistor (28) in series with the power connection to one of the motor's terminals. The resistor value is chosen such that a low voltage is dropped across it when motor current typical of the connected motor is flowing, to minimize power losses and to minimize the effect the added resistance has on the operation of the motor. As shown in FIG. 10, as rotor current (26) passes through the current-sensing resistor (28), a voltage (29) is developed that is proportional to the instantaneous current of the motor. This voltage includes an AC component, which corresponds to the AC component of motor current. This AC component allows the motor speed and rotation to be measured as described herein.

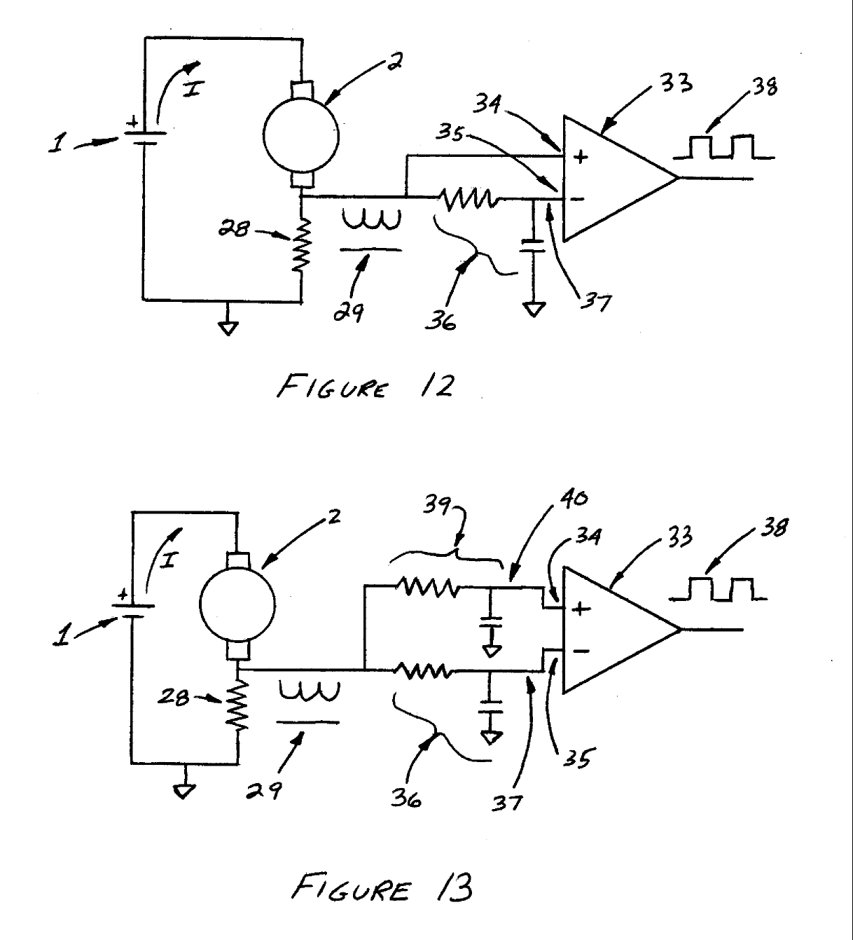

FIG. 11 is a printout of an oscilloscope screen shot taken of a running permanent magnet DC motor, showing the precise timing relationship between the motor's current & voltage waveforms and the rotation of the rotor. The motor used for this test had a single pair of magnets, two brushes, and a commutator with 5 segments (connected to 5 rotor windings). The large blue trace (30) is the output of an optical position sensor coupled to the motor's output shaft to provide a timing reference signal. The optical position sensor produces two complete cycles for every rotation of the motor shaft. The yellow trace (31) shows the motor's input current. The pink trace (32) shows the ripple voltage on the motor's terminals; note that the magnitude of this ripple voltage is much less than the DC voltage (not shown) that this ripple voltage is superimposed upon. The voltage and current waveforms are not exactly the rectified sine wave and inverted rectified sine wave (respectively) as predicted by theory because of the imperfect construction of the motor; however, the frequency and period of these waveforms are correct. Examination of these traces confirms the precise timing relationship between the motor's current and voltage waveforms and the rotation of the motor. There are exactly 10 cycles of ripple current and ripple voltage on the motor's input waveforms for every two output cycles from the optical position sensor, or for every 1 mechanical revolution of the motor; this agrees with the principles described herein.

Since the current drawn by the motor varies dependent upon the motor's mechanical load and other factors, the magnitude of the DC component of the current sense waveform will also vary. The long-term variation in the DC component of the current sense waveform (due to load changes, etc.) can easily exceed the short-term peak-to-peak magnitude of the AC component (ripple) in the current sense waveform. The AC component of the current sense waveform also varies, in both magnitude and frequency, depending on the motor's mechanical load, the motor's speed, and other factors.

In order to use the speed/position information embedded in the motor's current waveform, it is necessary to convert this periodic waveform into a form that is useful to a speed sensing or counting circuit. A detector circuit is used to convert the current sense waveform, which can vary in amplitude and frequency as described above, into a digital (two state) waveform of the same frequency. The detector circuit must be able to compensate for the variations in the current sense waveform.

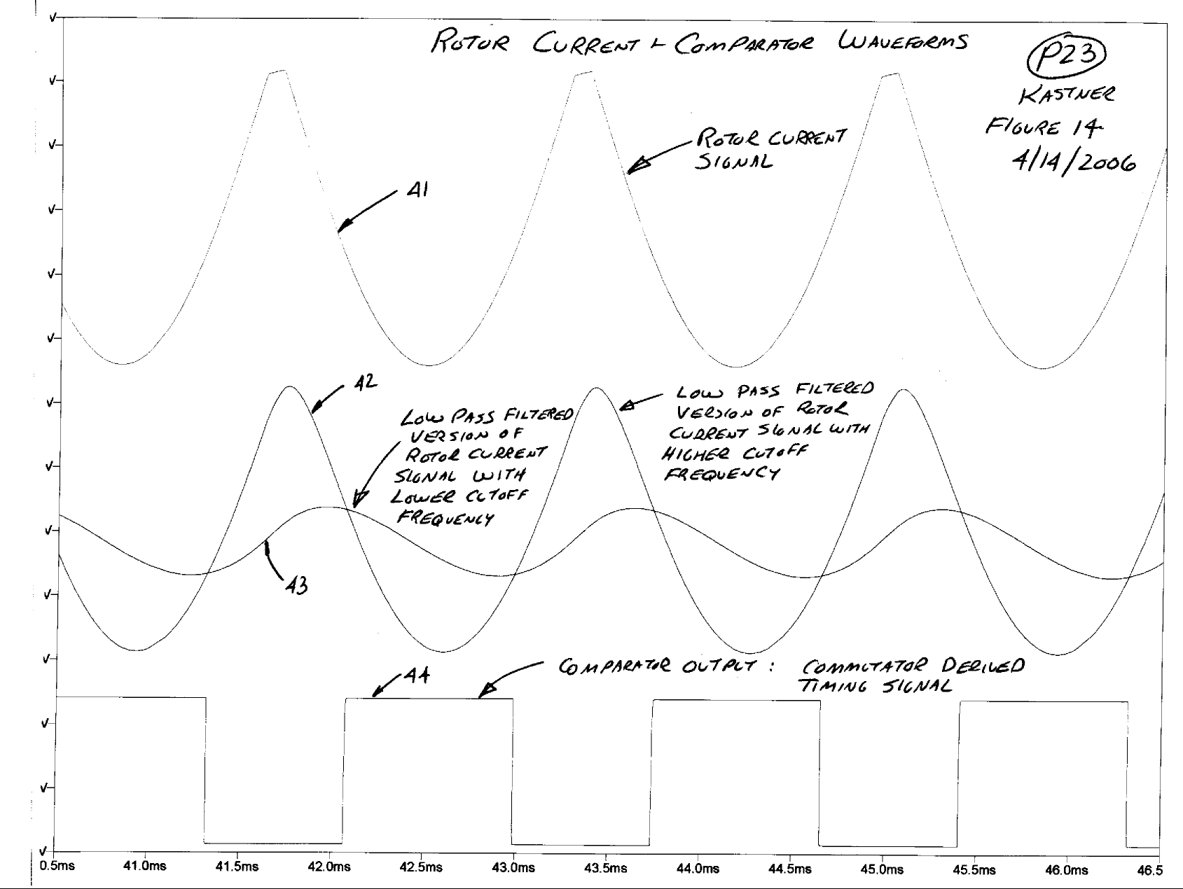

One very simple commutation detector circuit is shown in FIG. 12. The rotor current passes through current sense resistor (28) to create a current sense signal waveform (29). This current sense signal is fed into the two input terminals of a comparator (33); one input (34) receives the waveform directly from the current sense resistor (28), and the other input (35) receives it after it passes through a low pass filter (36). Note that while the filtered signal is shown feeding the inverting input, and the non-filtered signal is shown feeding the non-inverting input; this relationship can be reversed if the opposite comparator output signal polarity is desired. The low pass filter may be either the active or passive type; a passive filter (as shown in FIG. 12) is generally the preferred solution since it is simpler and cheaper and since it generally provides adequate performance. The cutoff frequency of the low pass filter (36) is chosen to be sufficiently low to filter out most or all or the AC component of the current sense waveform (29). This leaves the DC component or “average” value of the current sense waveform (37) on the filter's output and thus on the comparator's second input (35). The comparator (33) compares the instantaneous current signal (29) to the average current signal (37) from the filter's output. The comparator's output (38) is at the digital high or “one” state when the instantaneous current is greater than the average current, and at the digital low or “zero” state when the instantaneous current is less than the average current. As previously stated, this output polarity can be reversed if desired by reversing the connections to the comparator's inverting and non-inverting inputs.

In actual practice, the current sense signal (29) from the current sense resistor (28) is likely to include high-frequency electrical noise. This can cause the instantaneous current signal to transition through the average current value more than once per commutation cycle, and give a false indication of the motor's speed and of its cumulative number of revolutions. It can also potentially damage the comparator or other detection circuitry. One solution to these problems, as shown in FIG. 13, is to feed both of the comparator's inputs (34 & 35) with low-pass filtered versions of the current sense signal, rather than feeding a filtered version of the current sense signal to just 1 of the inputs, as was shown in FIG. 12. While both of the comparator's inputs (34 & 35) are fed with low-pass filtered versions of the same current-sense signal, the low-pass filters (36 & 39) have different cutoff frequencies. This provides the comparator's two inputs with two slightly different signals; while both signals have the same DC component value and AC component frequency, they have slightly different AC component magnitudes and phases. The instantaneous magnitude of these two low-pass filtered versions of the current signals (37 & 40) will swap having a greater magnitude twice during each motor commutation cycle. This causes the comparator's output signal (38) to create one digital output cycle for every motor commutation cycle, thus allowing those commutation cycles to be timed or counted.

In a preferred embodiment, at least one of the filters will have a cutoff frequency near the frequency of the commutation signal that the circuit is detecting. This provides adequate noise filtering on both of the comparator's inputs, while providing two different frequency-correct versions of the current sense signal with two different amplitudes and phases, as needed.

FIG. 14 shows the waveforms for a typical differentially-filtered current-sense based commutation detector, as described above. The top trace (41) is the unfiltered current sense signal from the current sense resistor. The two middle traces (42) and (43) are low-pass filtered versions of this current sense signal, filtered with low pass filters with two different cutoff frequencies. Trace (42) is the filtered version of the current signal from the low pass filter with the higher cutoff frequency, while trace (43) is the filtered version of the current signal from the low pass filter with the lower cutoff frequency. The bottom trace (44) is the comparator output that results when these two filtered signals are fed into a comparator. The polarity of the comparator output changes whenever the two filtered current signals swap having the greater amplitude. When trace (42) has a greater magnitude than trace (43), the output of the comparator is a digital low; when trace (43) has a greater magnitude than trace (42), the output of the comparator is a digital hi.

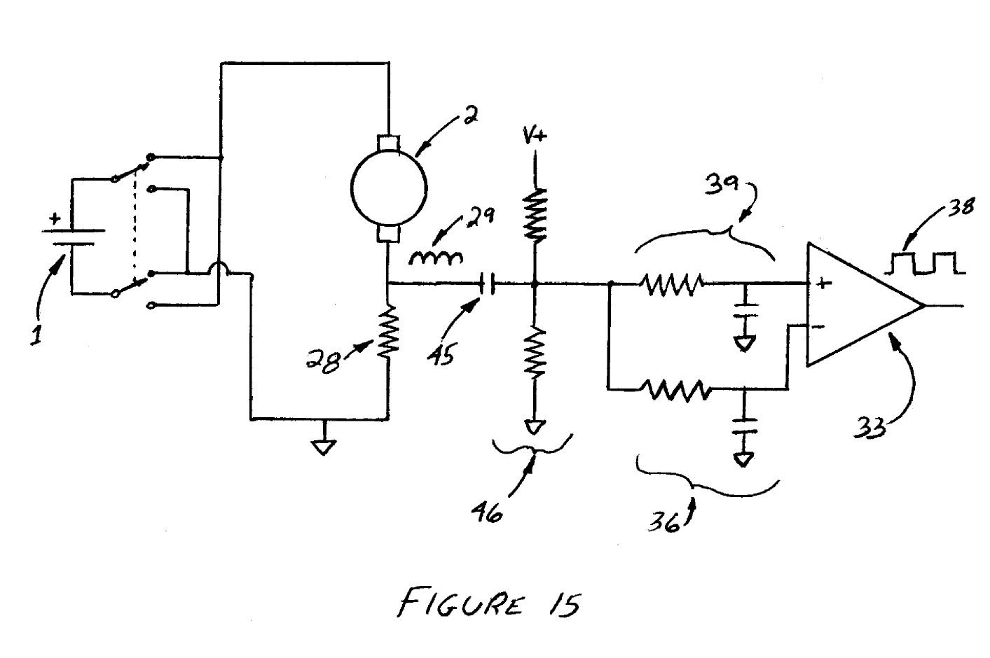

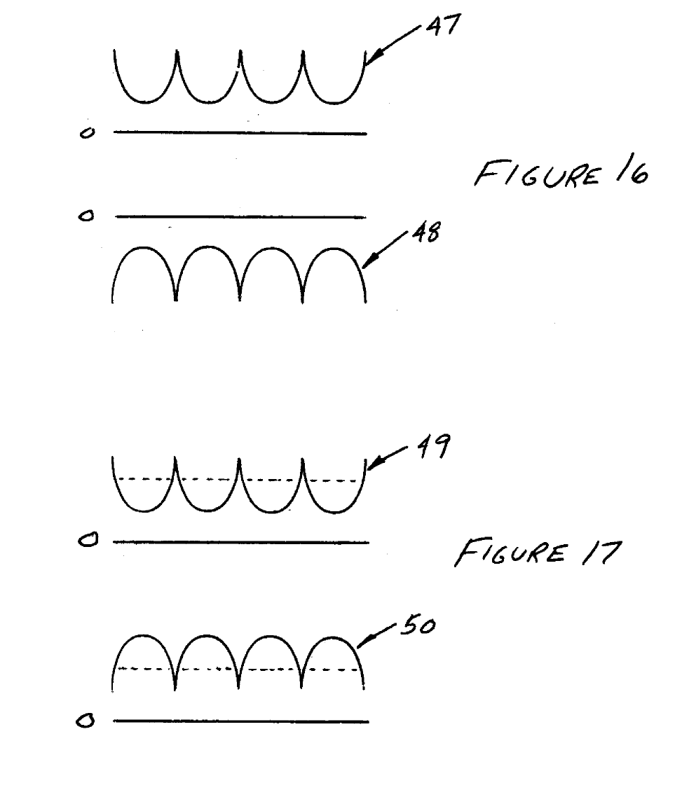

One of the advantages of DC motors is their ability to be easily reversed; this is very useful in many applications, including power tools such as electric drills. Motor reversal is accomplished by reversing the polarity of the voltage applied to the winding in single-winding DC motors, or to one of the windings in multiple-winding DC motors. Reversing the polarity of the voltage applied to the rotor connections also reverses the polarity of the current in the rotor winding. The current sense signal that is applied to the inputs of the comparator in a comparator-based commutation detector must be within the common-mode input voltage range of the comparator in order to ensure that the comparator's output will be a correct indication of the signals fed into its inputs. With the rotor current reversed (to reverse the motor), the current sense signal will have the opposite polarity. If the bias power supply that powers the comparator is dual-ended (including a positive and a negative voltage with respect to circuit ground), the current sense signals will likely remain within the common mode input voltage range of the comparator, and the comparator should be able to detect and react to the current sense signals appropriately. If the bias power supply that powers the comparator is single ended (a positive voltage and circuit ground), the change in current sense signal polarity will likely place the current sense signals out of the comparator's input common mode voltage range. This would likely render the comparator unable to sense and react to the current sense signals at its inputs. One possible solution to this problem is shown in FIG. 15. The current sense signal (29) is AC coupled/DC blocked with a capacitor (45), before entering the low-pass filters (36) & (39) of the detector's comparator (33). A resistor biasing network (46) ensures that the incoming signal is always within the common mode voltage range of the comparator. FIG. 16 shows the current sense signal for the forward (47) and reverse (48) directions at the current sense resistor (28) (prior to passing through the AC coupling/DC blocking capacitor (45) and biasing circuitry (46). FIG. 17 shows the current sense signal for the forward (49) and reverse (50) directions after passing through the AC coupling/DC blocking capacitor (45) and biasing circuitry (46). Note that for both the forward and reverse directions, the current sense signal inputs to the low pass filters are now always positive, such that they remain within the input common mode voltage range for the comparator (and thus ensuring proper operation of the commutation detector comparator (33)).

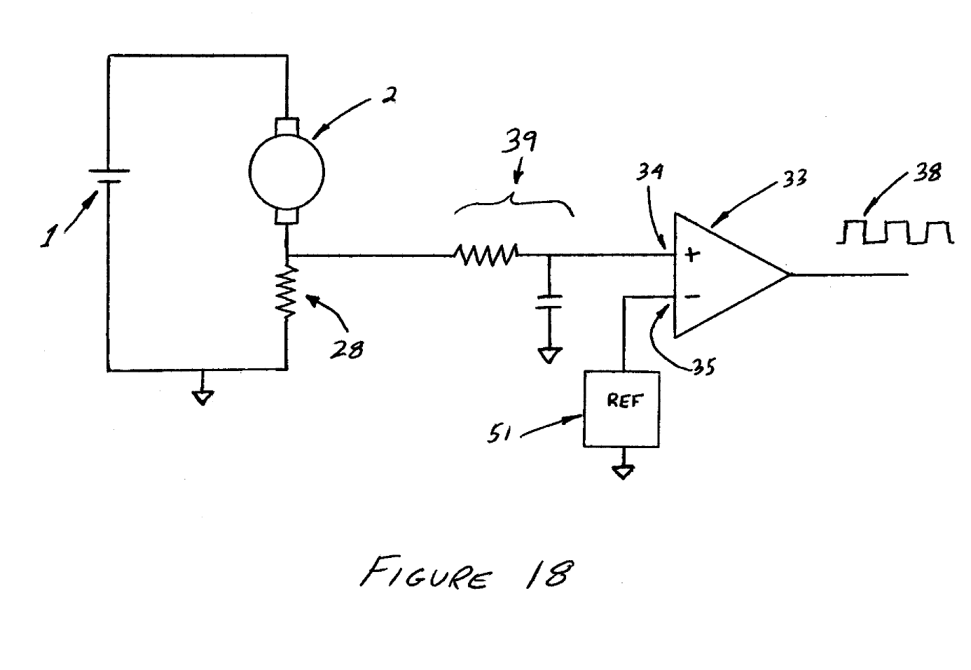

In some cases it may be desirable to compare the current sense signal to a fixed or controllable reference signal, instead of to the averaged or differentially filtered version of the same current sense signal. In such cases, the second input of the comparator can be a fixed or controlled voltage reference (51), as shown in FIG. 18.

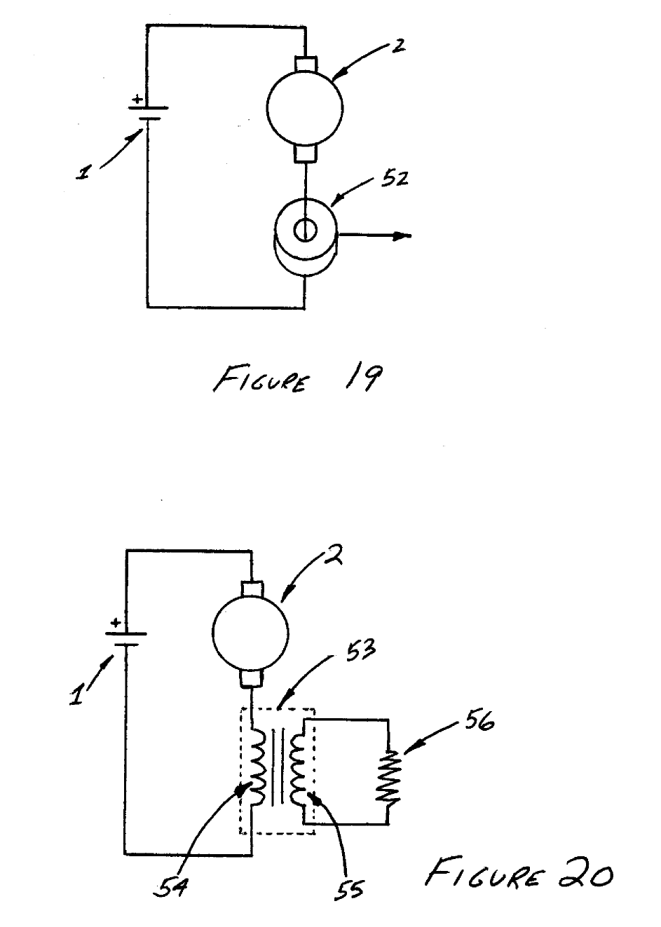

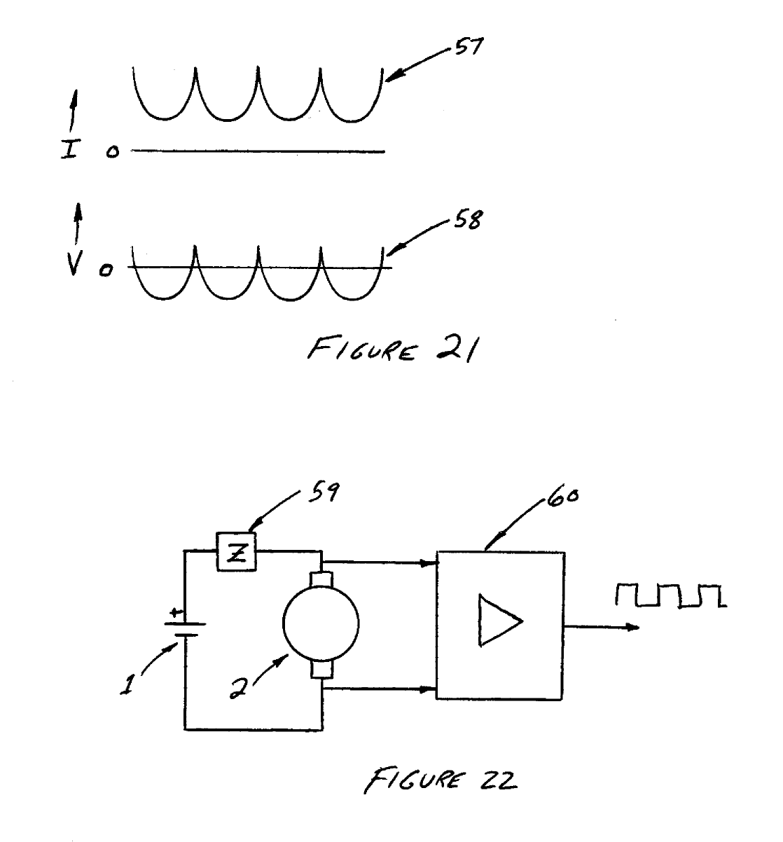

In some cases, it may be desirable to have the current sensing signal electrically (galvanically) isolated from the motor's power leads. In these cases, an isolated current sensor (52) can be used instead of a current sense resistor, as shown in FIG. 19. The simplest type of isolated current sensor is a current transformer (53), as shown in FIG. 20. A current flows in the secondary (55) of the current transformer (53) that is proportional to the AC component of the current that flows in the primary (54) of the current transformer. This secondary current flows through a load resistor (56) that is connected across the secondary of the current transformer, developing a voltage that is proportional to the AC component of the primary current; that signal is used to derive rotor speed and/or total rotor rotations as previously described. FIG. 21 shows an example of the motor current (57) that passes through the current transformer's primary, and the resulting motor current signal (58) that is subsequently developed at the secondary of the current sense transformer. Note that the since the current transformer does not couple the DC component of the primary current, the current transformer works equally well for both the forward and reverse directions of the motor, and no further AC coupling/DC blocking circuitry is required. If necessary, the output voltage of the load resistor can be biased with a simple voltage divider biasing network to ensure that it remains within the common mode voltage range of the comparator or other detector circuitry.

Note that if the motor is powered from a direct current power source, the current transformer will have DC current flowing through its primary. The current transformer must be a type that is capable of operating with this continuous DC primary current without saturating; if the current transformer does saturate, the output signal will no longer be an accurate representation of the input current.

Other types of electrically isolated current sensors also exist and could also be used. These include current sensors based on Hall Effect sensors, linear optocouplers, electromagnetic couplers, and active circuits that digitize the signal and send it across a standard optocoupler or signal transformer as either a PWM signal or as digital data. Any of these approaches are valid and will work, and remain within the scope of this invention. However, their use is generally reserved for special conditions where it is necessary, since they are generally more complex and therefore more expensive than previously described circuitry.

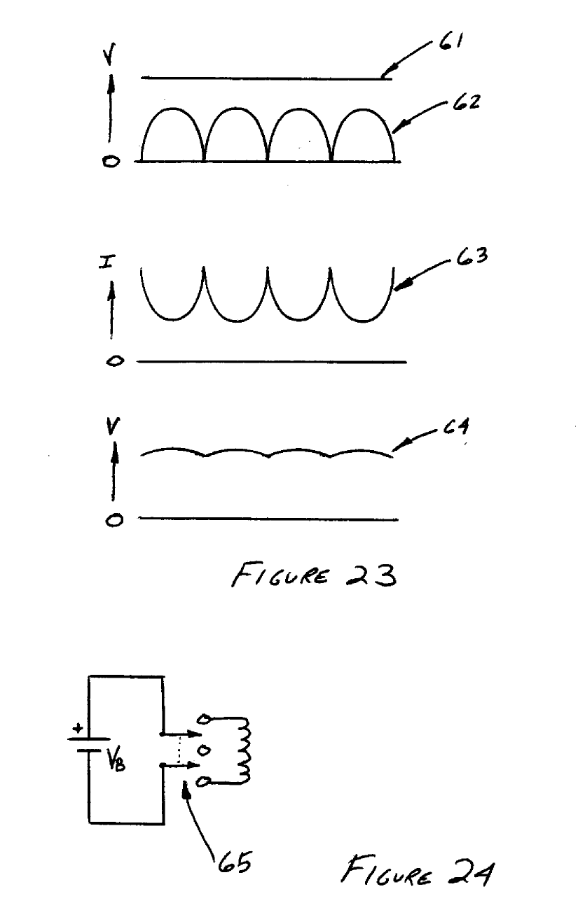

While the schematics shown to this point show direct, zero impedance connections between the battery/voltage source and the motor, in reality some impedance (59) does exist in these connections, as shown in FIG. 22. Because of this power source impedance, and even if the supply voltage contains no AC ripple, the fluctuating counter-emf and resulting fluctuating motor current will cause a small AC component (ripple voltage) to appear on the substantially DC voltage measured across the motor's power leads. The magnitude of this AC voltage component is largely determined by the ratio of the power connection impedance (59) to the rotor impedance (7), and the magnitude of the AC component of the motor current (current ripple). If this ripple voltage has a sufficiently large magnitude, a voltage detector (60) can be used to detect the commutation events (in place of the current detectors previously described) as shown in FIG. 22. This eliminates the need for a current sense resistor (28) or alternate current sensor. FIG. 23 shows an example of the waveforms for the supply voltage (61), motor counter-emf voltage (62), motor current (63), and motor voltage (64) for this ripple-voltage sensing version of a commutation detection circuit.

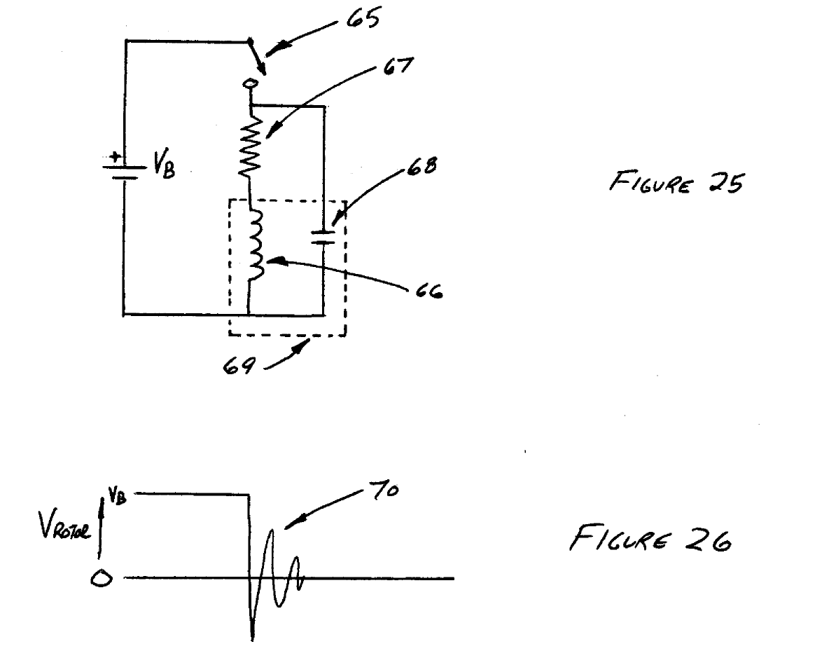

Detecting variations in motor current and motor voltage due to periodic variations in counter-emf, as described above, is not the only way that signals present on the motor's leads can be used to accurately detect commutation events (and so determine motor speed and cumulative motor travel). Since the rotor windings are composed of a multitude of turns of a conductor (usually copper wire), they inherently have some inductance. As the brushes slide on the commutator, the electrical connections to the numerous rotor windings are repeatedly connected and disconnected. FIG. 24 is a simplified circuit schematic that shows the connections between the power source, the commutator & brushes, and a rotor winding. The commutator and brushes are represented by the switches (65) in this drawing.

When current flow in an inductor is suddenly interrupted, a phenomena known as “inductive kick” occurs. Current in the inductor attempts to continue to flow, resulting in a rapid increase in voltage across the inductor. The voltage increase continues until an arc occurs (allowing the current to continue to flow while dissipating the energy stored in the inductor) and/or until the energy in the inductor is discharged elsewhere (such as into the inductor's parasitic parallel capacitance). In a running DC motor, these arcs can sometimes be seen as sparks where the commutator and brushes meet.

FIG. 25 shows another electrical model of a motor's rotor, showing not only the inductance (66) of a rotor winding, but also the series resistance (67) and parallel parasitic capacitance (68) as well. The counter-emf of the rotor is not shown in this drawing. Once again, the switch (65) represents the commutator and brushes. When the switch is closed, the current in the winding builds. When the switch is opened, the inductance of the rotor attempts to keep the rotor current flowing. The energy contained in this inductance is discharged into an arc at the brush/commutator interface and into the parallel parasitic capacitance of the winding. Together, the rotor inductance and parallel parasitic capacitance make up a resonant LC circuit (69). Some of the energy initially contained in the current in rotor's inductance is exchanged between that inductance (in the form of current) and the parasitic capacitance (in the form of voltage). This exchange of energy typically lasts for several cycles, with the frequency determined by the inductance and parasitic capacitance values:

F=½π√LC

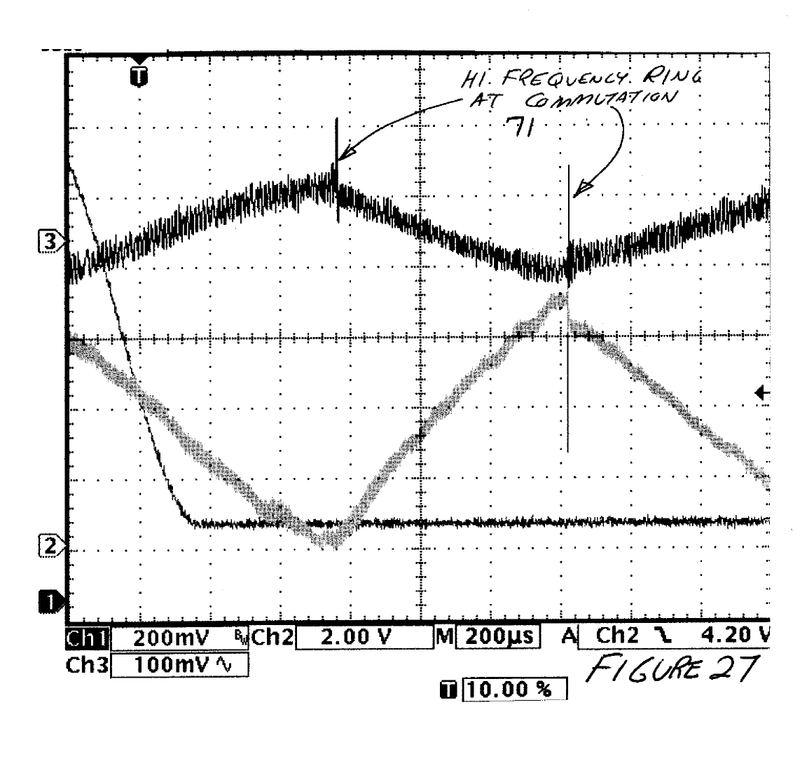

The resulting oscillation is often called a “ring” or a “glitch”. The resistance of the rotor winding serves to dampen this oscillation by dissipating the energy, such that after several cycles it is largely damped out. FIG. 26 shows the typical ring voltage (70) that results when a rotor winding's current path is interrupted by the commutator. The actual ring frequency is normally quite high (typically in the MHz range), due to the relatively low rotor winding section inductance and the very low value of parasitic capacitance in the rotor winding section. FIG. 27 is an oscilloscope plot showing an actual commutation voltage ring (71) on the terminals of a running motor

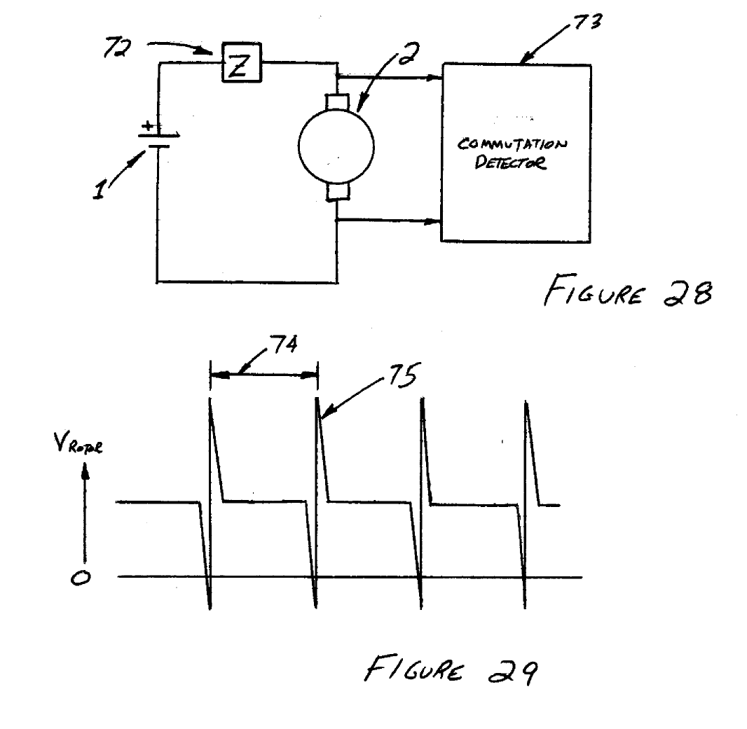

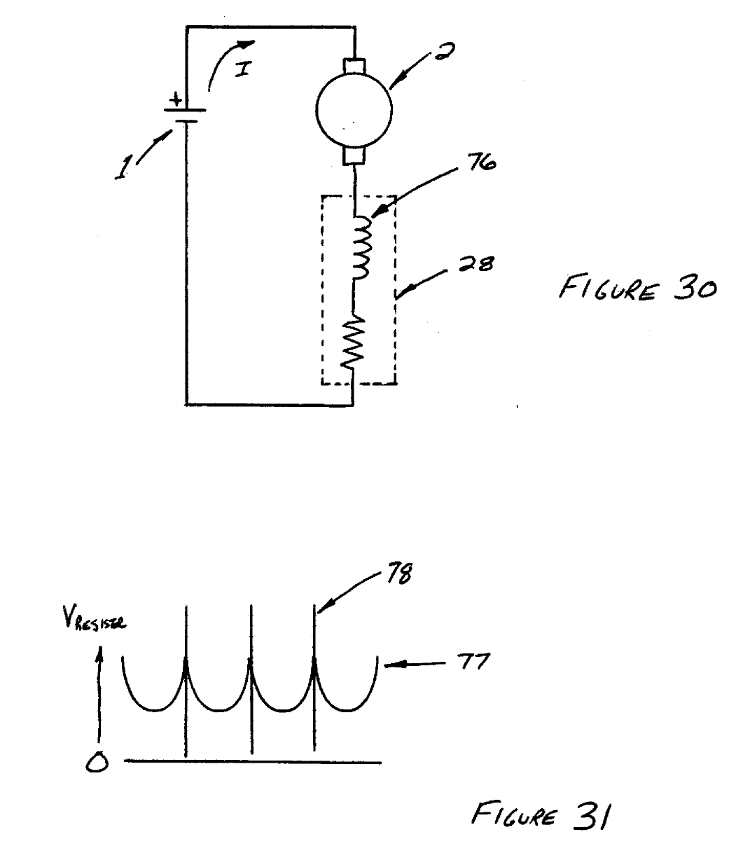

This oscillation or ring regularly occurs every time a rotor winding connection is opened, for any of the rotor winding sections in the motor's rotor. The number of these winding opening events is fixed at some integer number per revolution of the motor. In the case of a two-brush motor with an odd number commutator bar segments, that number is twice the number of commutator bar segments or rotor winding sections. The sample motor used for evaluation had two brushes and 5 commutator bars (and 5 rotor winding sections), so exactly ten commutation events or cycles occur per every revolution of the motor. Because of this signal regularity, the normally undesirable voltage-ring phenomena can be used as an alternate timing signal to determine the speed of the motor or to count the revolutions of the motor. FIG. 28 is a block diagram that generically shows one method to detect this timing-accurate ring signal. The battery or alternate power source that powers the motor, along with the connecting wiring, have some series impedance (72), and that impedance is typically higher at higher frequencies (due in part to the skin effect on conductors at high frequencies). Because of this impedance, the LC ring voltage described above can often be detected at the motor's brush terminals with a detector circuit (73). The amount of energy present in this commutation ring is quite limited, and the ring frequency, as previously discussed, is quite high. For these reasons and others, the ring voltage that occurs at commutation is a very short duration event. FIG. 29 shows the regular period (74) of the ring voltage (75) that appears on the motor's brush leads. In this figure the ring event has been widened to make it easier to see; in an actual working motor, these ring pulses are normally very brief and are often quite difficult to see even with an oscilloscope (as shown in FIG. 27).

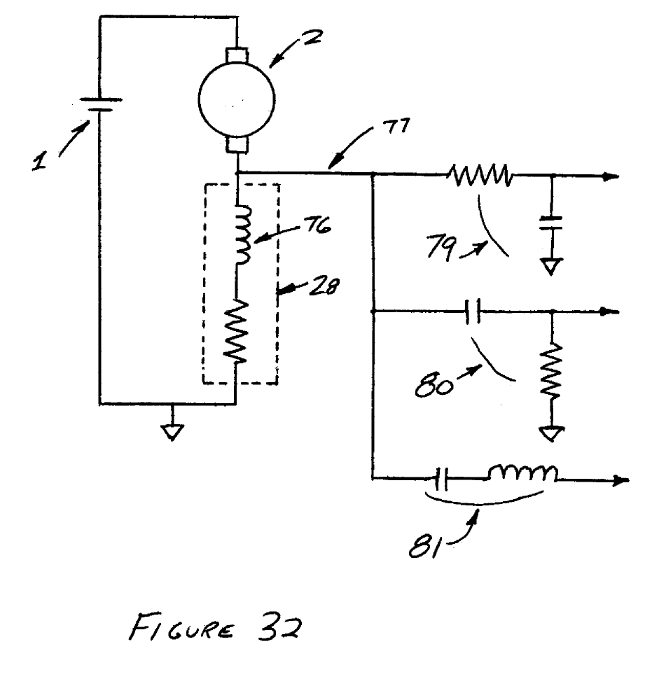

If a motor current sense resistor (28) is present in the circuit, the commutation ring voltage can often also be sensed across that current sense resistor. This is largely due to the fact that the current sense resistor will have some parasitic inductance (76), as shown in FIG. 30. Because the commutation ring voltage is at a very high frequency, the current sense resistor's parasitic inductance presents a relatively high impedance to this ring voltage; this allows the ring voltage to be detected across the low-resistance-value current sense resistor as a “commutation glitch”. FIG. 31 shows a typical current-sense-resistor voltage waveform (77) that is observed when looking across the current sense resistor of a running motor, including this commutation “glitch” (78).

If a current sense resistor is used with a motor, its primary purpose is typically to sense the DC value of motor current. The voltage signal (77) developed across the current sense resistor (28) can be separated into DC and AC components with a parallel low pass filter (79) (to detect the DC component or “average” value) and high pass filter (80) or band pass filter (81) (to detect the AC component or ring voltage). This is shown in FIG. 32. A band-pass filter (81) is a particularly viable solution if the commutation ring signal is well characterized and of a known & relatively fixed frequency. Once again, these filters can be either passive or active filters, but are generally passive filters due to their simplicity, lower cost, and adequate performance.

FIG. 33 shows one way that the commutation ring voltage waveform can be sensed in order to detect the motor's speed and/or to count the motor's cumulative rotations. The ring voltage/commutation glitch (78) that occurs at commutation events typically oscillates to voltages significantly beyond the DC voltage on the rotor. By comparing the rotor or current sense resistor voltage to a reference voltage (82) that is set higher than the DC voltage of the current sense signal, the commutation events can be detected with a comparator or similar detector circuit.

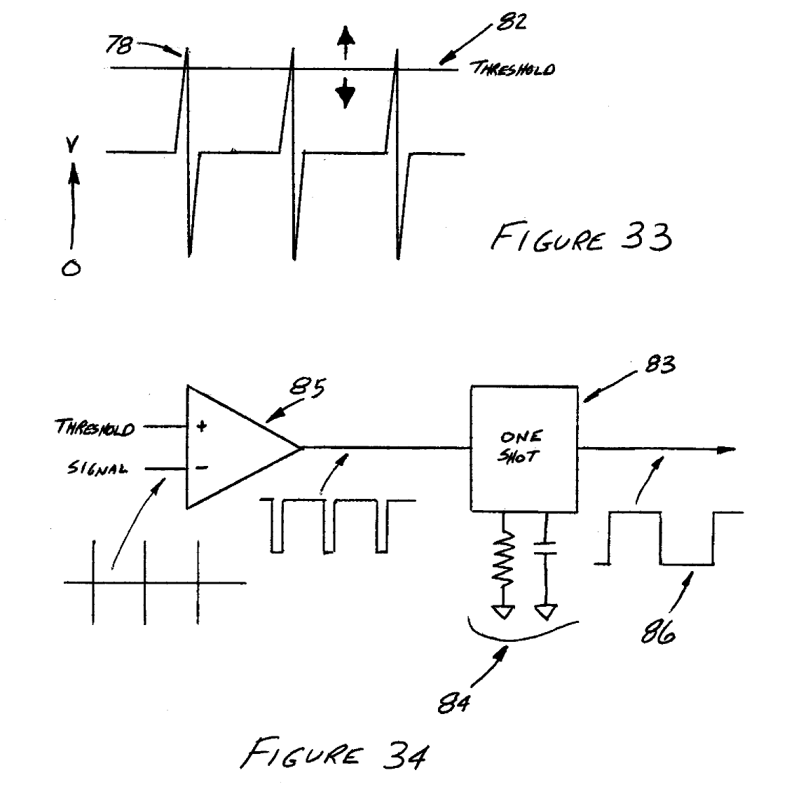

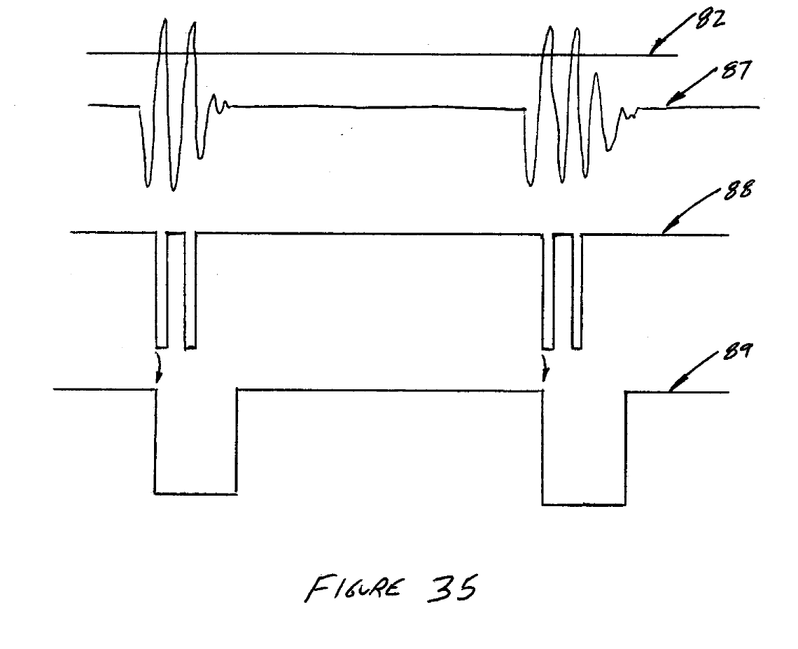

Since several cycles of the high-frequency oscillation ring voltage signal may occur before the oscillation is damped out, it is possible that the comparator or other detector could detect or count multiple pulses for a single real commutation event; this could provide erroneous speed or cumulative motor revolution information. In order to prevent this from happening, the output of the detector can be de-bounced with a de-bounce circuit. One simple type of de-bounce circuit is a one-shot multivibrator (83), as shown in FIG. 34. When the detector (85) detects the first cycle of the commutation ring voltage signal for a given commutation event, it triggers the one-shot multivibrator to change output states. The multivibrator then remains in that “set” state for a predetermined period of time before returning to the initial “reset” state. The amount of time that the one-shot remains in the set state is determined by timing components (84) (typically a resistor and a capacitor) which are connected to the one-shot multivibrator. While it is in the set state, the multivibrator is unresponsive to further pulses from the commutation detector (85) . . . and thus from subsequent pulses from the same commutation event. The timeout period of the one-shot multivibrator is set to be sufficiently fast to ensure that it has returned to the reset/ready state before the next commutation event, at all possible motor speeds. The resulting output from the multivibrator (86) is a digital waveform at a frequency identical to the commutation rate of the motor being monitored. FIG. 35 shows the waveforms for multiple ring cycle commutation events (87), the reference voltage (82), the comparator/detector output for this multiple ring waveform (88), and the one-shot multivibrator output (89), which is a waveform with a single debounced cycle per commutation event.

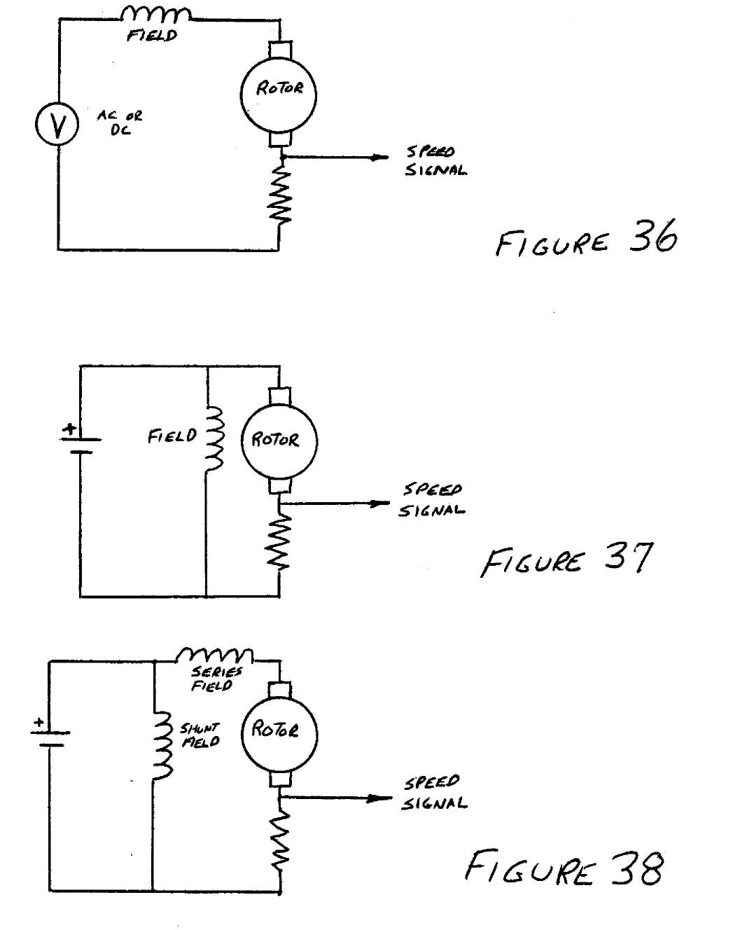

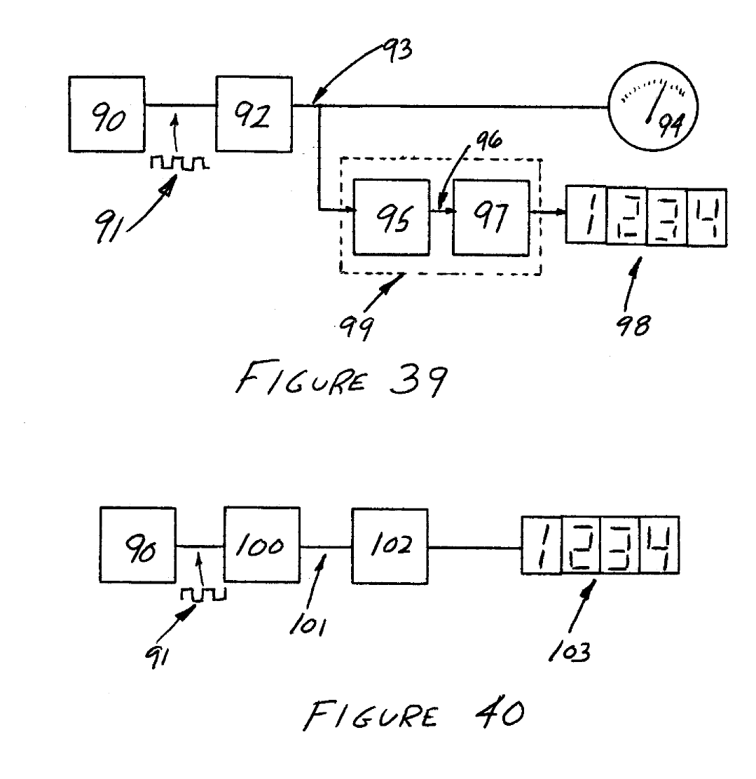

While permanent magnet DC motors have been used in most of the descriptions and figures contained herein (for simplicity), the methods and circuits described are equally valid for detecting the speed and/or counting the revolutions of other types of DC and brushed motors. These alternate motor types include, but are not limited to, series wound/universal DC motors (shown in schematically in FIG. 36), shunt wound DC motors (shown schematically in FIG. 37), and compound wound DC motors (shown schematically in FIG. 38). In all DC motor types, the rotor current waveforms described herein will be present in some form, and the techniques for monitoring those waveforms described herein can be adapted to accurately measure the motor speed and/or count the motor's revolutions.

One of the simplest uses of the motor speed detector's output signal would be a simple speed indicator. A block diagram for one speed detector and indicator circuit is shown in FIG. 39. A commutation event detector (90), like those previously described, is used to detect the individual motor commutation events and generate a waveform (91) with a frequency and period matching the motor's commutation frequency and period. A frequency to voltage or frequency to current converter circuit (92) subsequently generates a voltage or current signal (93) that is proportional to the commutation detector's output frequency, and therefore also proportional to the motor's rotational speed. This voltage or current signal is used to drive an analog meter (94) and/or an analog to digital converter (95). If a digital display is used, the digital output (96) from the analog to digital converter is then fed into a digital display driver (97), which generates the needed signals to drive a digital display (98), such as an LED (light emitting diode) display or an LCD (liquid crystal display).

In one preferred embodiment, the analog to digital converter (95) and digital display driver (97) are one component (99), such the industry standard ICL7106 A/D converter/3½ digit LCD driver.

Since a multiple, fixed number of commutation events occur for every revolution of the motor, this fixed divisor must be taken into account as a scale factor (divide ratio) when displaying the motor speed information.

It will be recognized by those skilled in the art that the motor speed monitoring circuit described herein is one of many possible circuits that could be used to detect, monitor, and display the speed information generated by the commutation detector circuit; the circuit presented above is but one example. It will be further recognized by those skilled in the art that the speed signal can be extracted at any point along the signal path within this circuitry and sent to and/or be monitored by other circuitry, such as for remote monitoring of the motor speed.

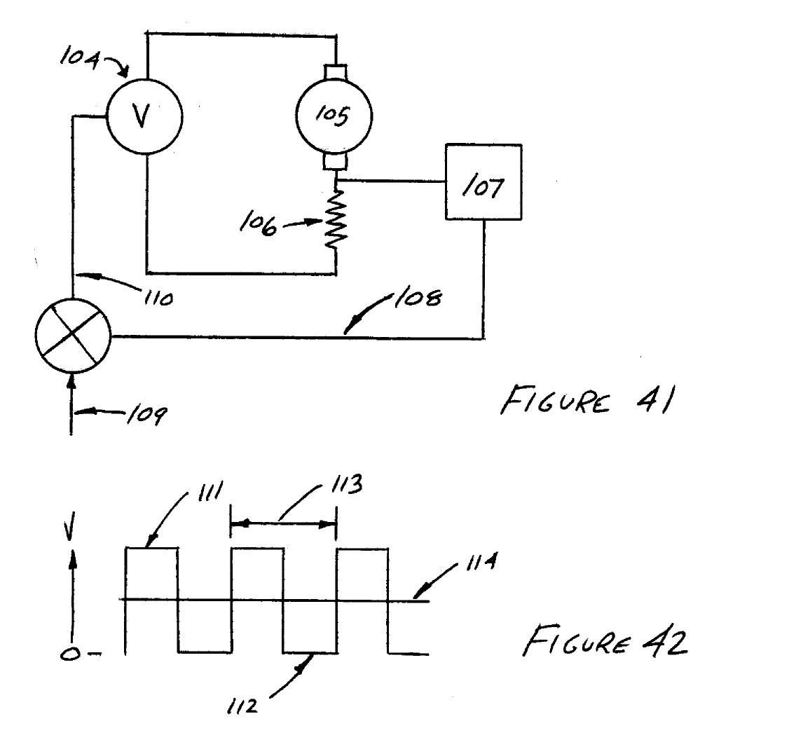

Similarly, one of the simplest uses of the motor revolution detector would be a simple revolution counter display, as shown in FIG. 40. In this case, the output (91) of the commutation detector (90) is monitored by a digital counter (100). The output (101) of the digital counter (100) drives a digital display driver (102), which drives a digital display (103) as described above. In this case, however, the displayed information is cumulative motor revolutions.

As was the case for the speed indicating circuit, a multiple, fixed number of commutation events occur for every revolution of the motor. Therefore, that fixed divisor must once again be taken into account as a scale factor (divide ratio) when displaying the motor revolution information.

It will be recognized by those skilled in the art that the motor revolution counting & monitoring circuit described herein is but one of many possible circuits that could be used to monitor and display the accumulated motor revolution information generated by the commutation detector circuit; the circuit presented above is but one example. It will be further recognized that the motor revolution count information could be extracted at any point along the signal path within this circuitry and sent to and/or be monitored by other circuitry, such as for remote monitoring of the cumulative motor revolutions.

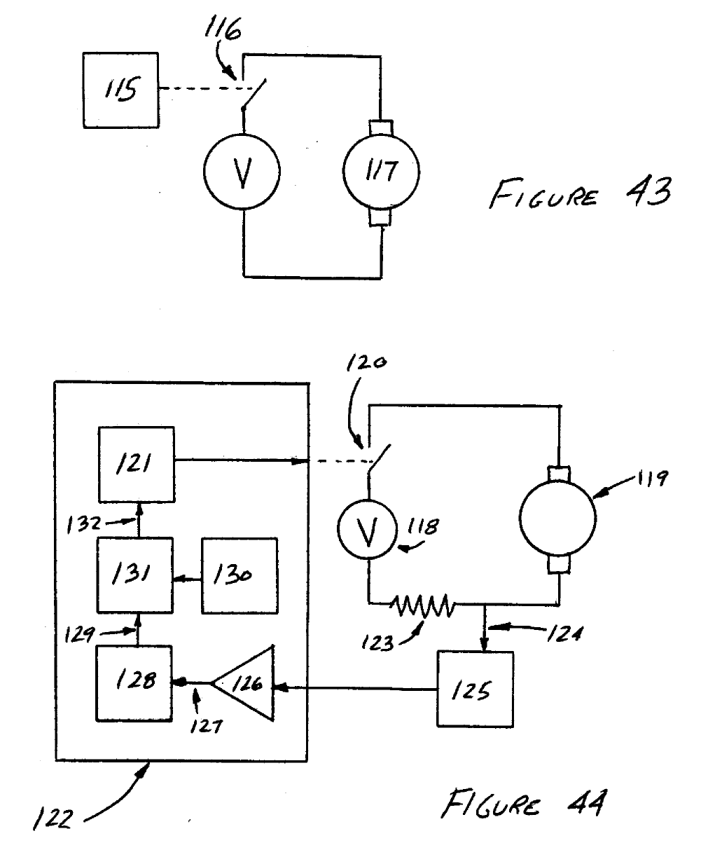

Another application for the motor speed signal detected by the detector described herein is a motor speed control. A block diagram of a simple motor speed control circuit using these techniques is shown in FIG. 41. A controllable voltage source (104) provides power to a DC motor (105). A current sense resistor or other sensing element (106) detects signals present on the motor's rotor/commutator/brush leads, and feeds them to a speed detector (107). The speed detector generates an output signal (108) that is proportional to the motor's actual speed. This detected speed signal is subtracted from a command speed signal (109) (which may be fixed, user controlled, or controlled by some other means). The resulting speed error signal (110) controls the controllable voltage source (104) in order to adjust the drive voltage applied to the motor, and thus to adjust the motor's speed so that it matches the desired speed. Thus, the speed detector is the speed sensor for a simple motor speed controller. Additional control elements could be added to this circuit (such as proportional, derivative, integral control) to adjust the way that the motor controller commands the motor to respond to speed errors. These additional control elements will be evident to those skilled in the art.

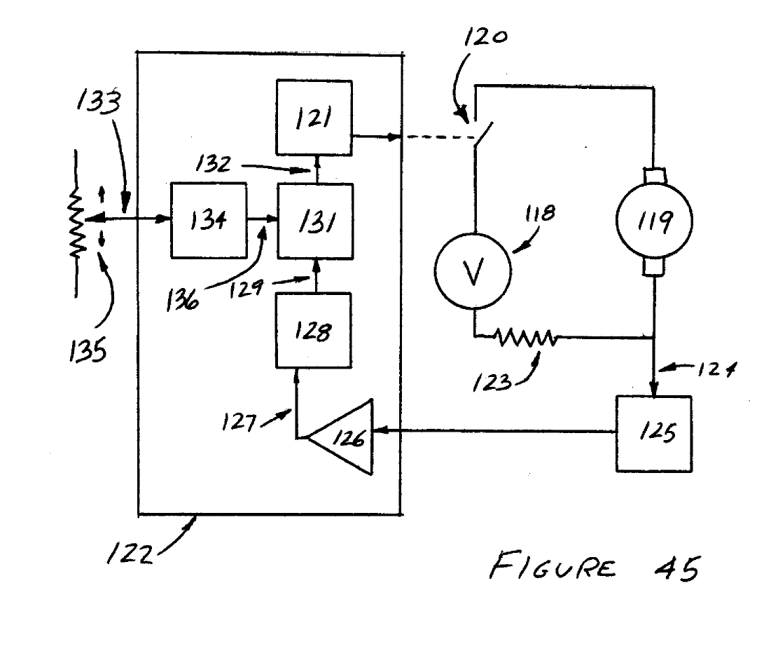

The simplest way to adjust the speed of a DC motor is by changing the voltage applied to its terminals. However, in most cases, a fixed-voltage power source (such as a battery) is used to power the motor. When this is the case, the effective voltage applied to the terminals of the motor is generally adjusted instead. The most common method of adjusting the effective motor voltage while using a constant source voltage or otherwise uncontrolled voltage source is pulse width modulation (PWM), as shown in FIG. 42. The voltage applied to the motor is rapidly switched between full supply voltage (111) and zero volts (112) at a frequency (113) that is sufficiently high to allow the rotational inertial of the motor to act as an integrator for the pulsing supply voltage. The effective motor voltage (114) is the average voltage applied to the motor, which is the product of the full supply voltage (113) and the duty cycle (the relative portion of the time that the supply voltage is applied to the motor). FIG. 43 is a block diagram that shows how pulse width modulation is used to control motor speed. A PWM controller (115) controls a semiconductor switch (116) (such as a bipolar power transistor, MOSFET, IGBT, etc.) to control the portion of the time (duty cycle) that the supply voltage is applied to the motor (117). This switch alternately connects the motor to the full supply voltage (111) and to zero volts (112) at some relatively high “chopping” rate (frequency) (113). PWM is very popular as a means of controlling motors because it is generally very efficient and inexpensive.

Modern motor speed controls generally use some type of “intelligent” circuitry to allow complex circuit functions at a minimal cost. This intelligent circuitry generally contains programmable circuit element(s) such as microcontrollers, digital signal processors, microprocessors, and/or programmable logic integrated circuits. These programmable elements allow motor speed controllers to offer significant advantages over motor speed controllers that use only discrete components; these advantages include lower cost, programmability, smaller size, and options such as greater functional complexity, built in diagnostic features, fault sensing/protection, etc. The motor speed and/or position sensors and sensing methods described herein are ideally suited for use with intelligent motor speed controls. FIG. 44 shows a block diagram of one such circuit. In this circuit, the connection between the supply voltage (118) and the motor (119) is controlled with a high speed electronic switch (120) (such as a MOSFET, IGBT, or bipolar transistor). This allows the effective motor voltage to be changed, as per the previous description of PWM motor drive. A PWM controller (121) in circuitry, preferably part of the intelligent circuit element (122) (a microcontroller in this case), controls the electronic switch. Motor current is sensed by a current sensing element (123) (here a current sensing resistor), and the resulting motor speed signal (124) is filtered as needed by filter circuitry (125) and sensed by a detector (126) (here a comparator) as previously discussed. In the preferred embodiment, the current detector (126) is part of the same intelligent circuit element (122) as that containing the PWM controller (121); this simplifies the circuit and reduces the circuit cost. The detector output signal (127) is fed to a timer/counter device (128) (again, preferably within the same intelligent circuit element (122)) to calculate a digital representation of the motor's speed. The resulting digital motor speed value (129) is digitally compared (131) (subtracted) from a digital reference value (130), which is typically stored in software, to determine an error signal (132) that indicates the difference between the existing motor speed and the reference value (130). This resulting error signal is used to modify the PWM controller's (121) duty cycle to correct the speed of the motor.

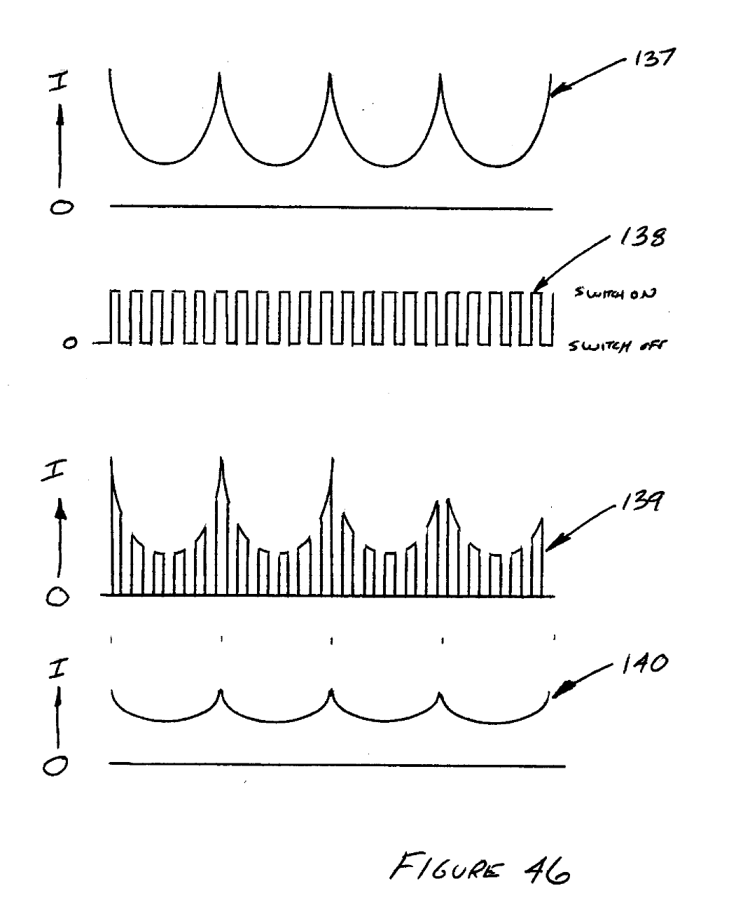

FIG. 45 shows a motor speed control very similar to that of FIG. 44. The difference is that the motor speed reference signal (133) (for desired motor speed) is externally adjustable rather than being fixed in software. This allows the motor speed to be adjusted as the motor is operated, which is a very useful feature in applications such as power tools. This externally adjustable reference signal (133) is an analog voltage in FIG. 45, but could also be a digital input without deviating from the underlying principle of the invention. In FIG. 45, the analog reference signal (133) comes from a potentiometer (135), which is a potentially inexpensive source of the reference signal. In a power tool application, this potentiometer might be part of the trigger switch. In the embodiment shown in FIG. 45, the analog reference signal (133) is read by an analog-to-digital converter (ADC) (134), which is preferentially also part of the intelligent device (122). Many inexpensive microcontrollers are available with built-in analog-to-digital converters, which allow an analog input voltage to be directly read. This greatly simplifies the circuit design, and allows for the least expensive reference signal input (such as from a potentiometer (135), as shown).

The operation of this circuit is as follows: As in the previous circuit (FIG. 44), the connection between the supply voltage (118) and the motor (119) is controlled with a high speed electronic switch (120) (such as a MOSFET, IGBT, or bipolar transistor). This allows the effective motor voltage to be changed, as per the previous description of PWM motor drive. A PWM controller (121) in circuitry, preferably part of the intelligent circuit element (122) (a microcontroller in this case), controls the electronic switch. Motor current is sensed by a current sensing element (123) (here a current sensing resistor), and the resulting motor speed signal (124) is filtered as needed by filter circuitry (125) and sensed by a detector (126) (here a comparator) as previously discussed. In the preferred embodiment, the current detector (126) is part of the same intelligent circuit element (122) as that containing the PWM controller (121); this simplifies the circuit and reduces the circuit cost. The detector output signal (127) is fed to a timer/counter device (128) (again, preferably within the same intelligent circuit element (122)) to calculate a digital representation of the motor's speed. The resulting digital motor speed value (129) is digitally compared (131) (subtracted) from an adjustable digital reference value (136), which is the output from the A/D converter (134), to determine an error signal (132) that indicates the difference between the motor speed and the reference value (136). This resulting error signal is used to modify the PWM controller's (121) duty cycle to correct the speed of the motor.

The PWM rate of the motor control signal may be faster than, the same speed as, or slower than the commutation rate of the motor. Each of these cases requires attention to the interaction of the PWM drive signal and the commutation signal.

FIG. 46 shows waveforms for an example case where the frequency of the PWM signal (138) is higher than the commutation frequency of the motor's rotor current signal (137). The top signal (137) shows the rotor current as it would appear if it were not modulated with a PWM control signal. The next signal (138) shows the PWM signal that is used to control the electronic switch. In this example, a high signal turns on the electronic switch, and a low signal turns it off. The next signal (139) shows the rotor current that results when the PWM signal drives the electronic switch (to switch the motor current on and off). The PWM signal is modulating the rotor current. The bottom trace (140) shows the motor current signal after passing through an appropriate low-pass filter, to remove the PWM modulation information. The current waveform signal has returned to a shape very similar to that of the rotor current for an unmodulated motor drive. It is evident that this filtered rotor current waveform, as applied to the commutation detector, has a period that is once again equal to the motor's commutation rate. Thus, the filtered rotor current signal (140) is an accurate source of motor speed information.

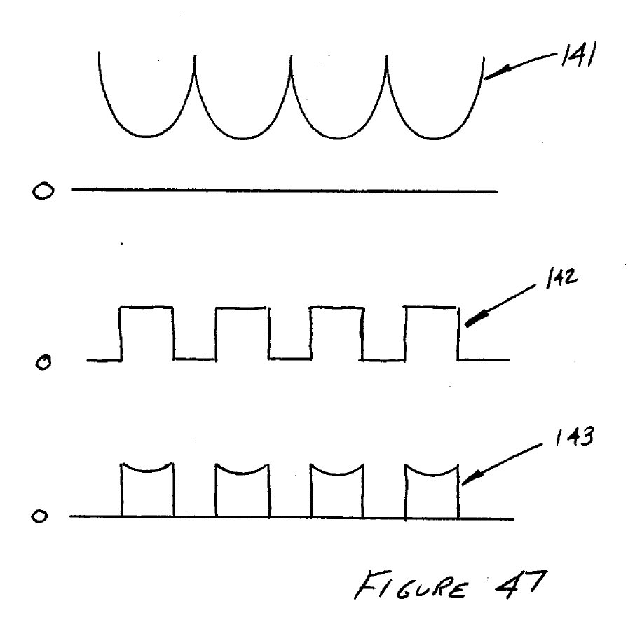

FIG. 47 shows the waveforms for another example case, where the PWM drive signal (142) is equal in frequency to the motor's commutation rate. The PWM signal (142) is purposely created at the commutation rate of the motor, and is synchronized to the commutation signal. Since the commutation rate varies with motor speed, the resulting PWM signal is necessarily a variable frequency PWM drive. The top trace (141) shows the motor current as it would appear if it were not modulated with a PWM control signal. The next trace (142) shows the PWM signal that is used to control the electronic switch. Once again, a high signal turns on the electronic switch, and a low signal turns it off. Note that the PWM signal is synchronized with and at the same frequency as the commutation signal. The next signal (143) shows the resulting modulated motor current. The motor current waveform is sensed by the commutation detector during the PWM “on” interval to determine the commutation rate of the motor and to provide a synchronization signal for the PWM controller.

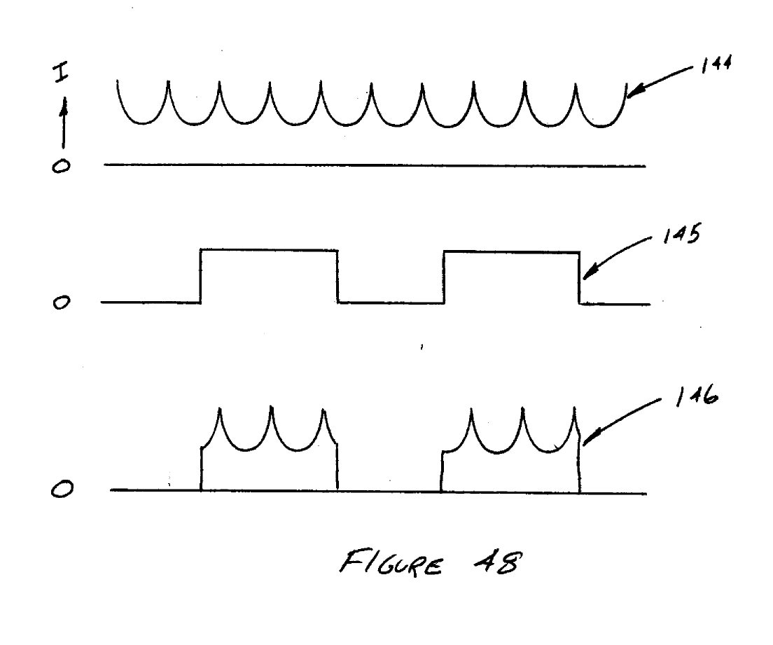

FIG. 48 shows the waveforms for another example case, where the PWM frequency is lower than the commutation frequency of the motor. Once again, the top trace (144) shows the motor current as it would appear if it were not modulated with a PWM control signal. The next trace (145) shows the PWM signal used to control the electronic switch. Once again, a high signal turns on the electronic switch, and a low signal turns it off. The bottom trace (146) shows the resulting modulated motor current with the PWM signal driving the electronic switch (to switch the motor current on and off). In this case, there are multiple commutation events within one PWM “on” interval. In order to eliminate the PWM event signal train from the composite PWM event & commutation event signal train, the commutation event detector is enabled during the PWM on interval and disabled during the PMW off interval, or its output is simply ignored during the PWM off interval. Either of these approaches is easily accomplished in software or hardware, particularly in the case where the detector and PWM controller are all within the same microcontroller or other intelligent device.

If the commutator switching voltage ring signal (commutation glitch) is used as the timing signal for determining motor speed, and the motor is controlled with a PWM speed control, the speed sensing circuitry must be able to distinguish between the high frequency ring signals caused by commutation switching and the similar high frequency ring signals caused by switching in the PWM driver circuitry. If the PWM based ring signals are counted or timed by the commutation speed sensing circuitry, either independently or in combination with the true commutation based speed signals, an erroneous indication of the motor speed and/or cumulative motor revolutions will result. FIG. 49 illustrates this problem and one potential solution for it. The top trace (147) shows the voltage ring signals that are caused by commutation events, which a true indication of the motor speed. The second trace (148) shows similar ring signals caused by PWM switching. The third trace (149) is a composite of the first and second traces, showing ring signals caused by both motor commutation and PWM drive switching; a combination of signals such as this is generally present as components on the voltage at the motor power leads. The forth trace (150) shows a blanking signal which disables the voltage ring detector except during the short intervals when a true commutation based voltage ring signal is expected. The window of time when the detectors are enabled is set by several factors that help determine when the next true commutation event is expected. These factors include an estimation of motor speed based on motor drive voltage and motor current, the known period between the previous set of commutation ring signals, and the maximum expected motor acceleration and deceleration rates (which determine the maximum possible deviation between adjacent commutation signals). The fifth trace (151) shows the reconstructed commutation pulse timing signal, with the non-commutation pulses removed.

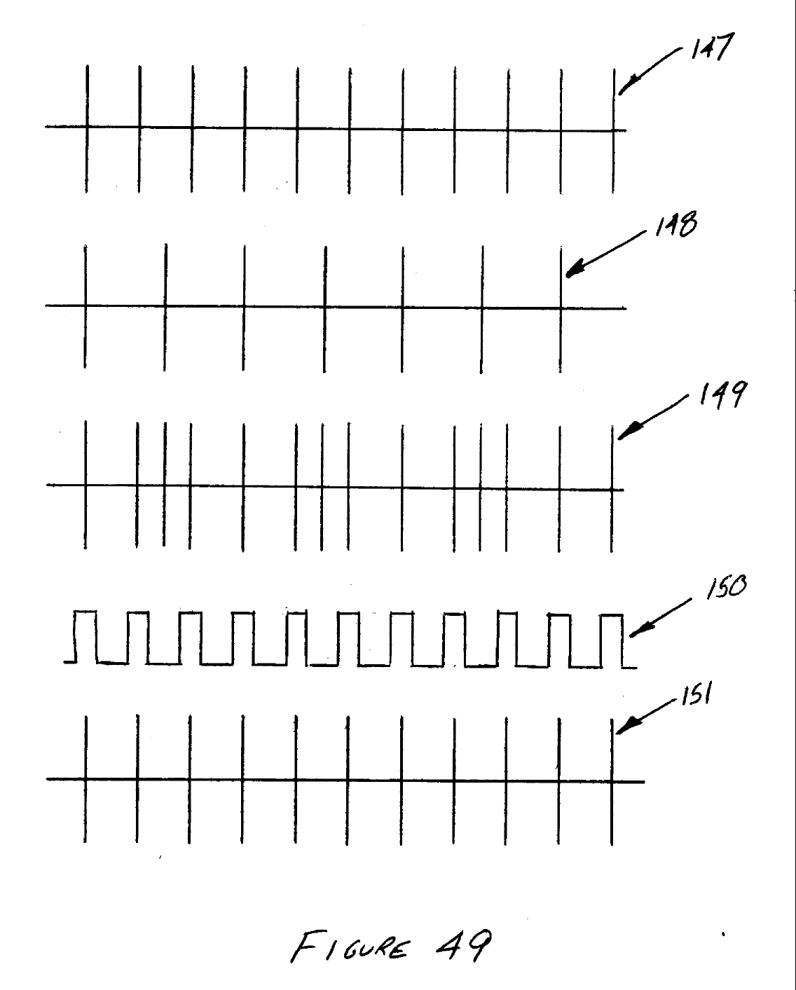

Windowed glitch detection of this sort is best accomplished with an intelligent circuit component such as a microcontroller; preferably this same intelligent circuit component will also contain the detector circuitry and PWM controller circuitry. Integrating multiple circuit functions into one component helps to maximize circuit features while minimizing circuit cost. The use of an intelligent device for windowed glitch detection allows further enhancements to the commutation detection process as well, as shown in FIG. 50. The blanking (enable/disable) signal (152) provides a window for detecting true commutation signals (153), while ignoring false commutation signals (154) that fall outside the blanking window, as described above. A missing true commutation pulse (155) (one which was not detected by the detector for some reason) can be virtually re-constructed by the intelligent device, because of the regular period (156) of the true commutation pulses (153) before and after the missing pulse. Since the motor's rotor can accelerate and decelerate at some maximum rate under normal operating conditions (because of the rotational inertia of the rotor), the period between any two adjacent true commutation pulses (153) will be very nearly the same as the period between another recent pair of adjacent commutation pulses. Otherwise stated, true commutation pulses occur on a very regular periodic basis on a short-term time scale. Because the period between detected commutation pulses before and after the missing pulse is very nearly the same, the intelligent device can assume that a missing pulse was in fact present where none was detected.

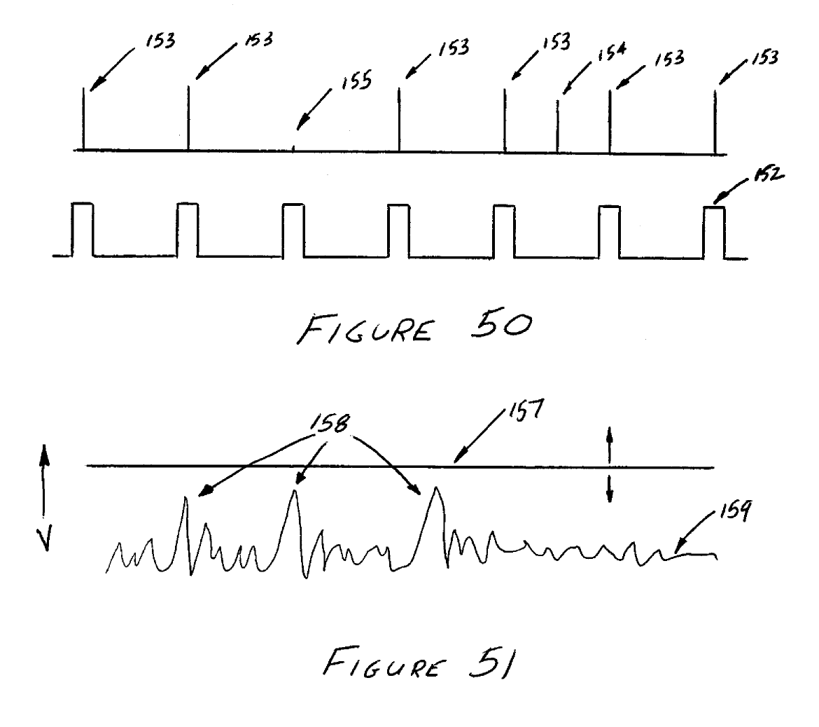

If the commutation detector is operating in an electrically noisy environment, noise signals may be interpreted as commutation events. Since true commutation events are likely to cause the largest amplitude voltage ring signals present on the brush leads, an adjustable detection threshold (157), as shown in FIG. 51, can be used to detect the true commutation voltage ring signals (158) while ignoring lesser amplitude voltage noise from the composite signal (159). A block diagram for one simple circuit to do this is shown in FIG. 52. The composite signal from the motor brushes (159) is fed into the commutation detector (160), and compared to an adjustable commutation detection threshold (157). The adjustable threshold level (157) is adjusted such that only true commutation voltage ring signals (158) have sufficient magnitude to trigger the detector circuit. Note that this detector can be one element of an intelligent circuit component, such as a comparator within a microcontroller. The adjustable threshold for the comparator can be generated by a D/A converter within the same microcontroller, or by a PWM output from the microcontroller that is subsequently filtered to generate a variable & controllable DC threshold level.

The intelligent device can use numerous methods to determine if the detector threshold is set to the proper level or if it needs to be adjusted. One method is comparing the cycle-to-cycle deviation in detected period. Since the period between commutation events is a direct reflection of the speed of the motor, any significant deviation in the period reflects an acceleration or deceleration of the motor. The rotational inertia of the motor's rotor and the motor's load, and the maximum torque which would normally be applied to that motor, places limits on the maximum possible acceleration or deceleration of the rotor, and thus upon the maximum deviation in detected period from cycle to cycle. Cycle to cycle period deviations outside of this calculated range indicate that the detection threshold is not set correctly.

Another method is using motor's counter-emf to make a rough determination of motor speed. While measuring the motor's counter-emf is not a precise method of determining the motor's speed, it can be sufficiently accurate to bracket the possible motor speeds, and thus the possible commutation period. If the measured motor speed & commutation period falls outside of the expected range, the detector threshold can simply be changed by the intelligent circuit element to compensate.

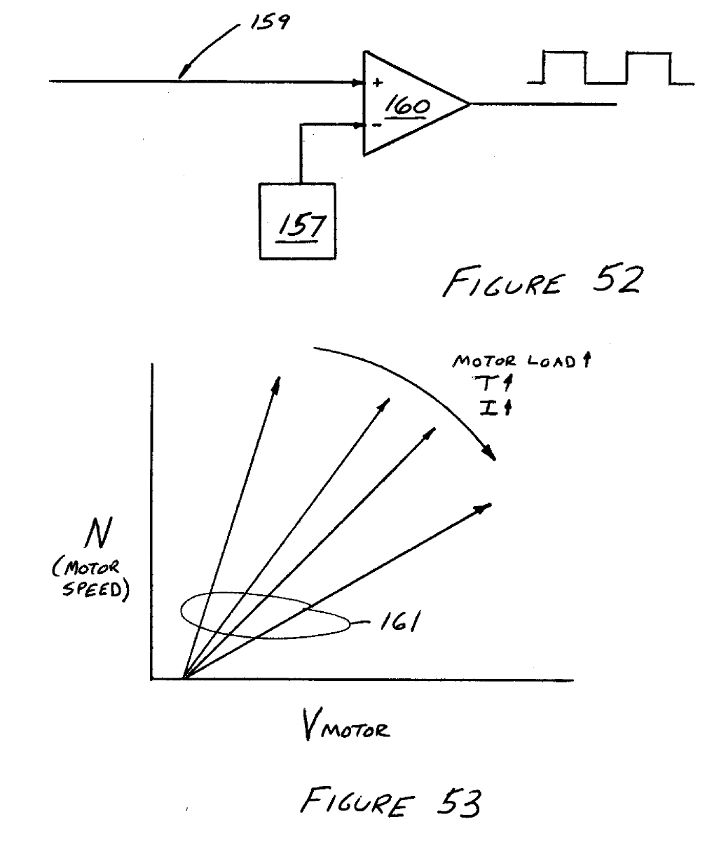

One method of using rotor-generated counter-emf to get a rough estimate of motor speed is to measure the motor current and motor voltage. By knowing the characteristics of the motor and storing them in the intelligent device (such as in a look-up table), a rough estimate of the motor's speed can be determined from the motor's voltage and current. This is because the motor's speed determines the amount of counter-emf generated, and therefore the amount of current that will flow for a given voltage applied to the motor's terminals. FIG. 53 shows a family of curves (161) showing how motor voltage and current relate to speed in a typical running DC motor. As the load on the motor increases, the torque the motor must apply to the load increases, which increases the motor current. Knowing the motor voltage and motor current thus allows you to estimate the motor's speed from known characteristics for that motor.

Another method of using rotor-generated counter-emf to get a rough estimate of motor speed is to momentarily stop driving the motor, and to then measure the voltage generated by the rotor as it continues to spin. If no rotor current is flowing, the voltage measured on the rotor will be the counter-emf, since there will be no drop across the effective resistance of the rotor. Again, since rotor speed determines counter-emf, the measured voltage can be used to determine a rough estimate of motor speed. FIG. 54 shows the linear relationship between counter-emf generated and rotor speed for a typical motor. The band of variation (162) is largely due to slight variations in motor construction; this band of variation is very narrow for a given motor type, allowing the motor characteristics to be effectively known and stored in the intelligent device.

There are several disadvantages to this method of measuring motor counter-emf, however. Best motor efficiency occurs when the rotor current is allowed to continue flowing or “freewheel” during the interval when the PWM drive is not active. Forcing the motor current to stop flowing or allowing it to decay to zero, in order to take the counter-emf voltage measurement, results in a loss of motor efficiency. It is possible to include a function in the drive circuit that allows the motor current freewheel path to be easily switched in and out of the circuit (to allow the counter-emf measurements while optimizing efficiency), but this adds considerable complexity and cost to the drive circuit. Also, at PWM duty cycles at or near 100%, there may be insufficient time for the rotor current to be forced to or allowed to decay to zero so that the counter-emf measurement can be taken.

In any case, measuring motor counter-emf is not a precise method of determining motor speed. While the counter-emf developed by a given rotor coil is directly proportional to motor speed, it is also affected by other factors. One of the most significant of these other factors is the strength of the magnetic field. The strength of the magnetic field is itself affected by numerous other factors, such as the temperature of the field winding, variations in the voltage feeding the field, etc. In addition to the variation in counter-emf generated by a particular rotor at a given speed, variations will also exist from one motor to the next due to variations and tolerances in the manufacturing process. If the motor's counter-emf is calculated by measuring the motor's current and voltage, additional factors such as rotor temperature and brush wear (which can affect actual and effective rotor resistance, respectively) add further variation to the counter-emf measured or calculated at a given motor speed. Thus, while measuring counter-emf methods using one of these methods can give you a rough estimate of rotor speed, it is unlikely to give a precise result.

Measuring the motor/rotor speed by sensing commutation events gives much more precise results. The measurement taken is the period of time between successive commutation events, which is effectively a direct measurement of motor/rotor speed, since a fixed, known, integer number of these events occurs with every motor rotation. The accuracy of this measurement is limited only by the resolution & accuracy of the circuitry measuring this time period, which can be very accurate for a very low cost. The accuracy of this time measurement is unaffected by factors such as motor load, motor temperature, unit to unit variations, etc. Thus, a motor control using commutation counting as a speed sensing method can provide a much more accurate motor speed control, for the same or less money than other methods (such as measuring counter-emf voltage).

Note that windowed ring detection is best combined with the debounce function previously described. This is easily accomplished for little cost when an intelligent device is used as the detector. Essentially, only one pulse is allowed per detector enable/blanking window; once that pulse has been detected, the detector is disabled until the next enable window.

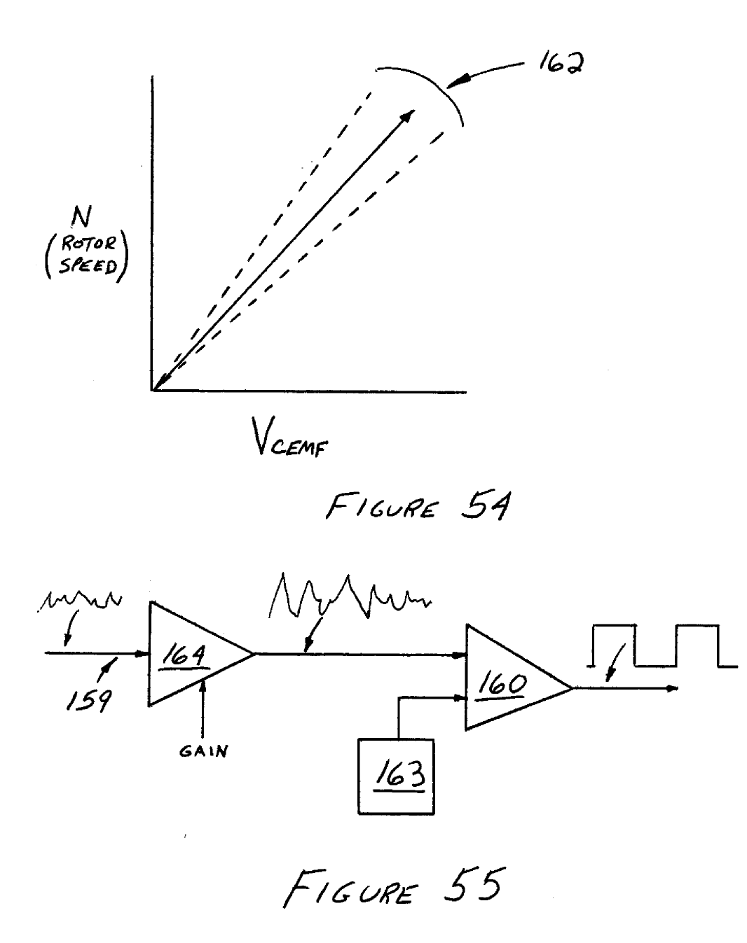

FIG. 55 shows another technique that uses an adjustable gain function to eliminate false commutation event detections while still detecting the true commutation ring signals. In this circuit, a fixed threshold signal (163) is fed into the commutation detector (160), and the composite signal from the motor leads (159) are fed through an adjustable gain amplifier (164). The gain of the adjustable gain amplifier is adjusted such that only true commutation signals are detected by the detector.

FIG. 56 shows the use of an automatic gain control (AGC) circuit (165) to adjust the gain of the adjustable gain amplifier (164) shown in FIG. 55. An AGC circuit could also be used to control the threshold fed into the detector in FIG. 52. In either case, the AGC circuit automatically and continuously adjusts the gain as necessary to allow only the commutation based ring signals to pass to the commutation detector (160). This AGC function may be implemented in hardware, or in software in the intelligent device.

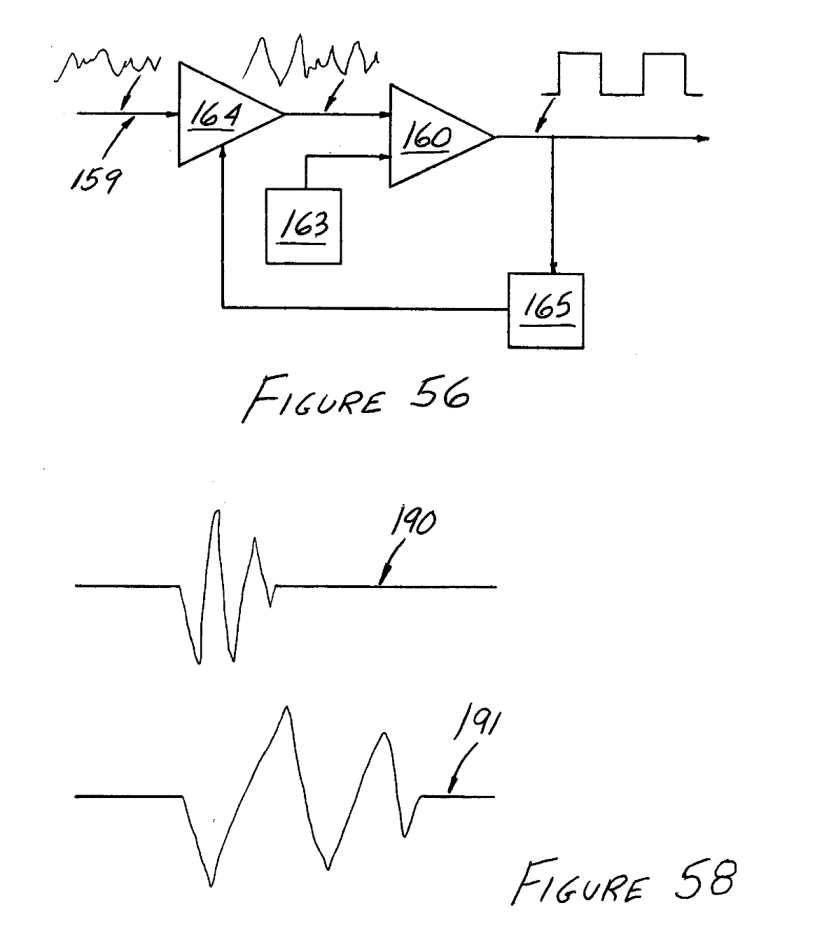

FIG. 57 shows a block diagram of a microcontroller (or other intelligent device) based motor speed control, with many of the needed circuit functions integrated into the intelligent device. This design uses blanking to help distinguish between commutation based ring signals and PWM based ring signals. However, a further enhancement is also included in this block diagram. The output of the PWM generator (185) is used to generate blanking (disable) intervals for the commutation detector, such that the PWM based ring signals are automatically masked out (since the detector is inactive when these rings occur). Operation of the circuit is as follows:

Motor (166) is supplied with power from supply voltage (118) via power switch (167) and current sense element (168). The power switch modulates the power delivered to the motor at a high frequency via PWM modulation. The current sensing element (168) detects the amount of motor current that flows as a result. Low pass filter (170) removes the high frequency (pwm) component of the current signal (169), and so provides a measurement of the average motor current (171), which is fed into the commutation detector (176). The detector is preferentially part of the intelligent device (186), but need not be. A reference pwm generator (172), preferably within the intelligent device (186) generates a pwm signal (173) whose duty cycle is proportional to the desired reference signal. Low pass filter (174) removes the high frequency (pwm) components to leave a DC value that is the current reference signal (175). The commutation detector (176) compares the motor current signal (171) to the reference value signal (175) to create a pulse train (177) whose frequency is the same as the motor's commutation rate. This pulse train is sent through a blanking circuit (178) that only lets the pulses that occur within the proper time windows to proceed to the timer/counter circuit (179). The timer/counter circuit measures the period of the commutation signal. The measured commutation period is digitally compared (184) to a reference value (180), which may either have been stored in the intelligent device's memory (181) or which may be the output of an analog-to-digital converter (182) that reads an external user control (183) such as a potentiometer, as shown. The digital comparison is generally done in software, but can also be done with hardware within the intelligent device.

The result of the digital comparison is sent to a PWM generator (185), preferably within the intelligent device (186), which generates a digital PWM pulse train signal (187) to control the power switch (167). This same digital PWM pulse train signal (187) is also sent to a blanking signal generator (188), preferably within the intelligent device (186), which generates the blanking signal (189) needed by blanking circuit (178).

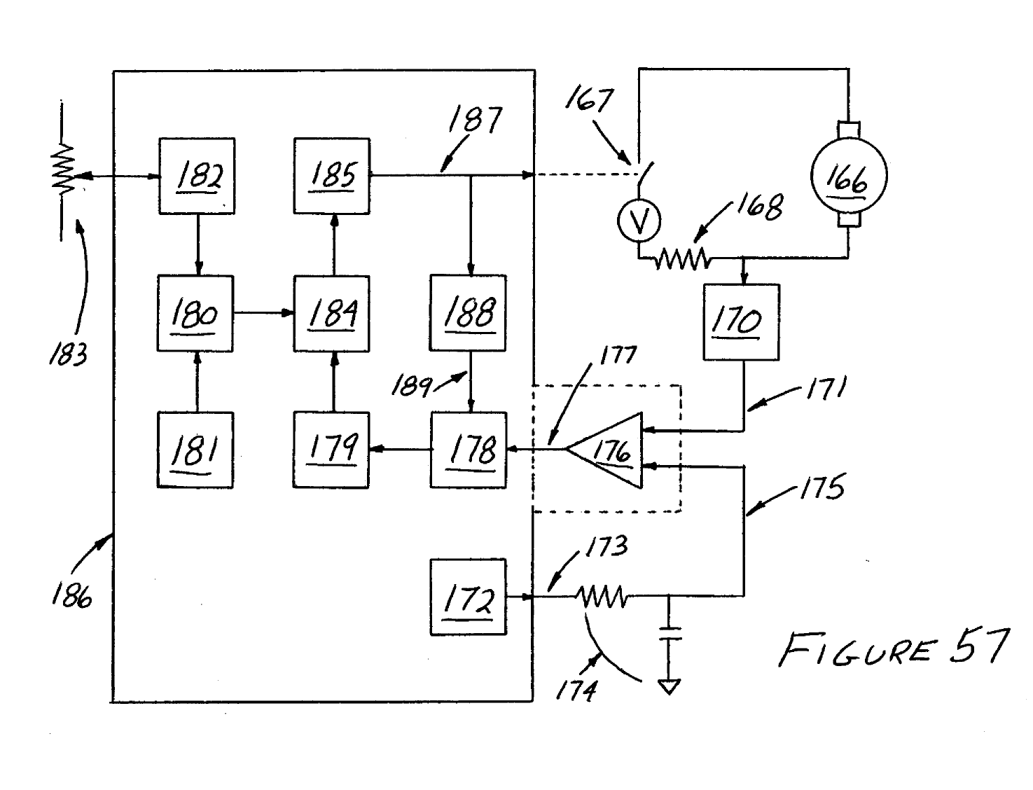

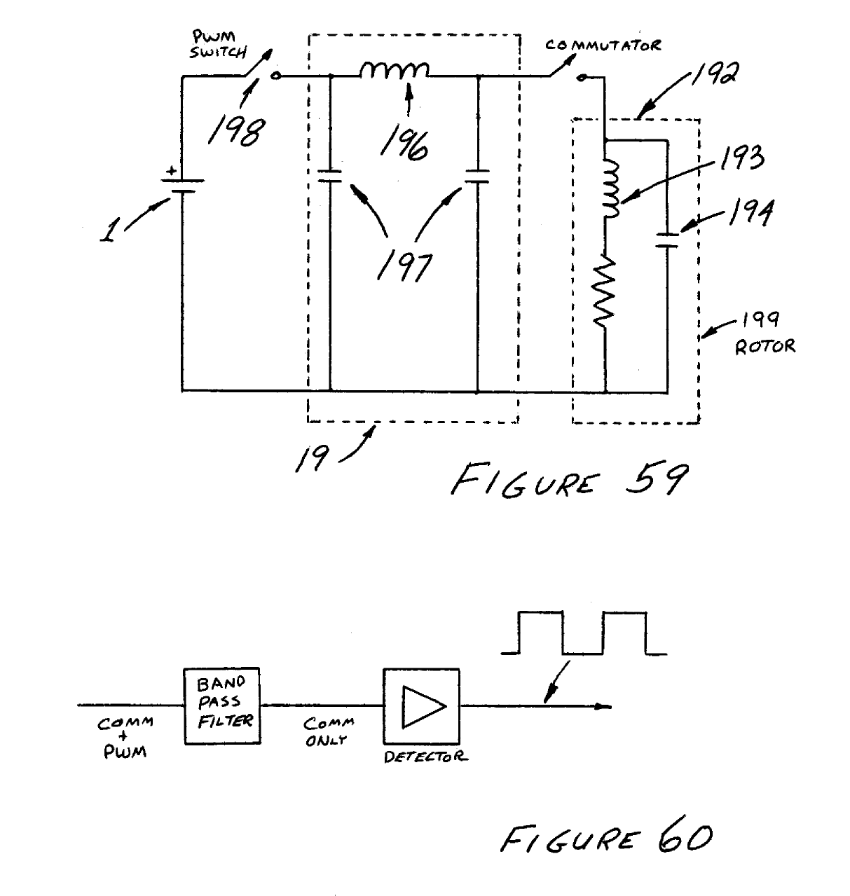

Another way to mask the PWM based ring signals such that only the commutation based ring signals can be detected is based upon the different frequencies that the commutation and PWM caused ring signals are likely to have; as shown in FIG. 58. In general, ringing voltage due to commutation (190) will have a different frequency than ringing voltage due to the PWM drive (191). FIG. 59 is a simplified schematic of the equivalent circuit of the motor and the drive circuitry that shows why these ring frequencies differ. The commutation based ring signals are caused by an LC tank circuit (192) that is entirely contained within the rotor of the motor; the main elements in that tank circuit are the inductance of the rotor winding (193) and the parasitic capacitance of that winding (194), which is primarily the inter-winding capacitance of that rotor winding. The resulting tank circuit has inductance and capacitance values that are typically very low in value; this results in a very high ring frequency. The LC tank circuit that is primarily active during PWM switching, however, is an entirely different LC tank circuit (195): it is largely composed of the distributed inductance (196) and distributed capacitance (197) of the circuit board traces and lead wires between the PWM switch (198) and the rotor (199). By carefully determining the ringing frequencies for the commutation and PWM caused voltage ringing events for a particular motor and controller combination, it is possible to construct a filter (200) to preferentially pass the commutation based ring signals to the commutation detector (201), as shown in FIG. 60. This filter may be a band-pass, band-stop, high pass, or low pass filter, depending on the frequencies involved in the particular application. Each motor & controller combination should be analyzed to determine the optimum filter. The filter may also be either an active or passive filter. Passive filters are generally preferred to reduce circuit cost; an active filter may be required if the commutation and PWM ring signals are very close in frequency.

FIG. 61 shows still another method of preventing the PMW voltage ringing signal from interfering with the commutation signal. A low-pass filter (202) is inserted between the pulse-width-modulated power source (203) and the motor (204). The low pass filter attenuates the high-frequency voltage ringing from the pulse-width-modulation, such that it is greatly reduced in amplitude when it reaches the motor. The amplitude of the resulting PWM switching/ring signal is therefore greatly reduced in magnitude (at the motor power terminals), making it much easier to discriminate the commutation signals from the PWM signals using methods previously described.

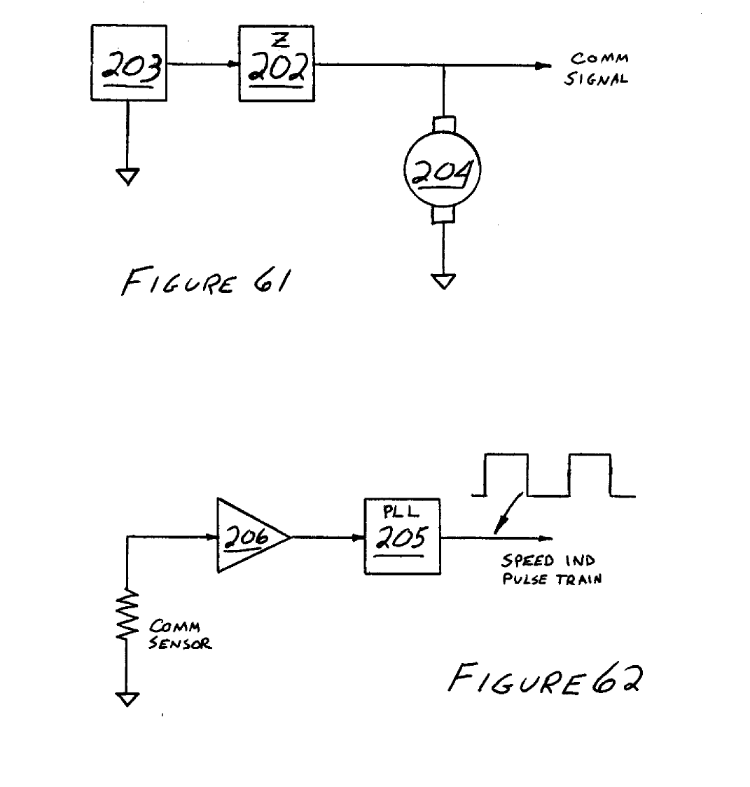

If the motor speed is known to vary by only a small amount, as is typical with a shunt wound DC motor, a phased locked loop (205) can be used to track the motor speed & rotation, as shown in FIG. 62. In this case, the commutation detector (206) acts as the synchronizing input for the phase locked loop. The phase locked loop automatically ignores ring signals that are far out of phase with the regular pattern that is generated by the commutation switching.

Controlling motor speed using the methods described above does not require any additional mechanical or electrical connections to the motor, since the motor speed is sensed and the motor speed is controlled using the motor's two existing electrical power connections. For that reason, it is possible to build a DC motor with a built in speed control. The speed control could be mounted on the outside of the motor, or inside of the motor can as shown in FIG. 63.

Largely because of recent advances in surface-mount electronic components, a circuit board (including the components mounted on it) can be built with a very low profile. In many cases, a complete motor driver circuit, including the power electronics, can be built onto a circuit board that is small enough to fit into the can of an existing DC motor. This allows the construction of the motor to remain largely unchanged from that of a standard DC motor. For example, the power connections (206), motor housing (207), rotor (208), stator windings or magnets (209), brushes (210), commutator (211), and output shaft (212) can be completely unchanged from an existing production motor. The only changes required are a means of securing the circuit board (213) within the housing of the motor, and re-routing the electrical power connections such that they pass through the circuit board on their way from the motor terminals to the brushes. Thus, the tooling expense for adding a motor controller to an existing motor would be minimal, and the resulting upgrade in motor performance would require a very small investment.

A motor with an internal speed control circuit could be directly substituted for a standard DC motor with identical outside dimensions, allowing a very simple and inexpensive upgrade to equipment designs that use existing standard DC motors. By placing the controller circuit within the existing motor can, the need for an enclosure to house the controller circuit is eliminated, as is the need for a place for that controller and interconnecting wiring. This reduces both overall system cost and overall system complexity over alternate motor controller solutions.

One use for DC motors with a built-in motor speed controller is fixed speed DC motors. The speed of a DC motor normally changes with changes in supply voltage and/or load. A built in motor controller designed to run the motor at a constant speed would keep that motor at constant speed, regardless of changes in supply voltage and/or load (within the operating range of the motor). Thus, the motor would be a constant speed drop-in replacement for standard DC motors . . . potentially enhancing the equipment containing the replaced motor.

One concern with placing the controller circuit board within the housing of the motor is the electrical noise associated at the motor commutator. Such electrical noise is known to cause interference and malfunction in unprotected electronic circuits. Circuit boards are commonly manufactured with multiple layers of copper conductors, separated by insulating layers of fiberglass or other materials. A large degree of protection for the circuit can be afforded by using the bottom circuit board layer (that closest to the commutator & brushes) as a solid copper “shield” plane; this layer will provide electric field shielding for the components (215) and interconnecting traces on the board, which would be preferentially mounted on the side of the board away from the commutator and brushes. This electrical noise protection is further enhanced if the motor can and end-cap are conductors; together with the shield layer on the circuit board, they will form a partial Faraday cage to further block the electrical noise signals from affecting the components on the circuit board.

A motor containing a built-in controller can provide a number of enhanced features over standard DC motors, including but not limited to precise constant speed operation (as described above), soft-starting, over-current protection, and fault detection. Most of these features provide the supplemental benefit of enhanced reliability for the motor, and potentially for the driven load as well. A soft-start feature, for example, can reduce the electrical stress on the motor brushes, commutator, and rotor windings, as well as the mechanical stress on the driven load. If the controller contains an intelligent element (such as a microcontroller) with programmable non-volatile memory, the controller can also record and store diagnostic information for later download, such as total run time, maximum current, number of starts and stops, etc.

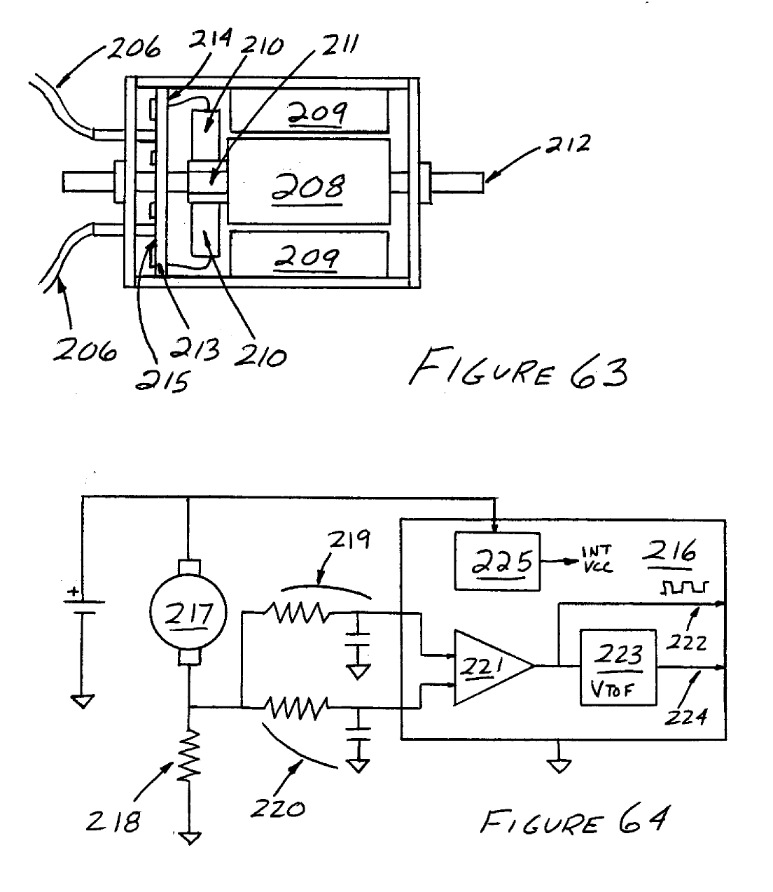

All or part of the active circuitry for a complete motor-speed sensing circuit based on detecting commutation events as described above can be built into a single application-specific integrated circuit (ASIC) (216), as shown in FIG. 64. In this example, the current through motor (217) is sensed with an external current sensor (218), and filtered with a pair of filters (219) and (220), which have different frequency response characteristics as described previously in this disclosure. The outputs from these filters are sensed by a detector (221) that is part of the ASIC. One possible output from the ASIC is a pulse train (222) whose frequency is the same or a multiple of the commutation frequency. In the example shown, the ASIC also includes a frequency to voltage converter (223) that provides a linear output (224) that is proportional to the commutation frequency. A linear output is ideal for driving an analog display, such as a simple motor speed meter. As an option, the ASIC could include an analog to digital converter, to provide a digital output. In a preferred embodiment, the ASIC would also include power conditioning circuitry (225) to provide the power to bias the internal circuitry within the ASIC from the unregulated and noisy power on the motor's terminals. One use of this integrated circuit would be to simplify and reduce the cost of motor tachometer circuits (for detecting motor speed), for instrumentation or as part of a speed control circuit.

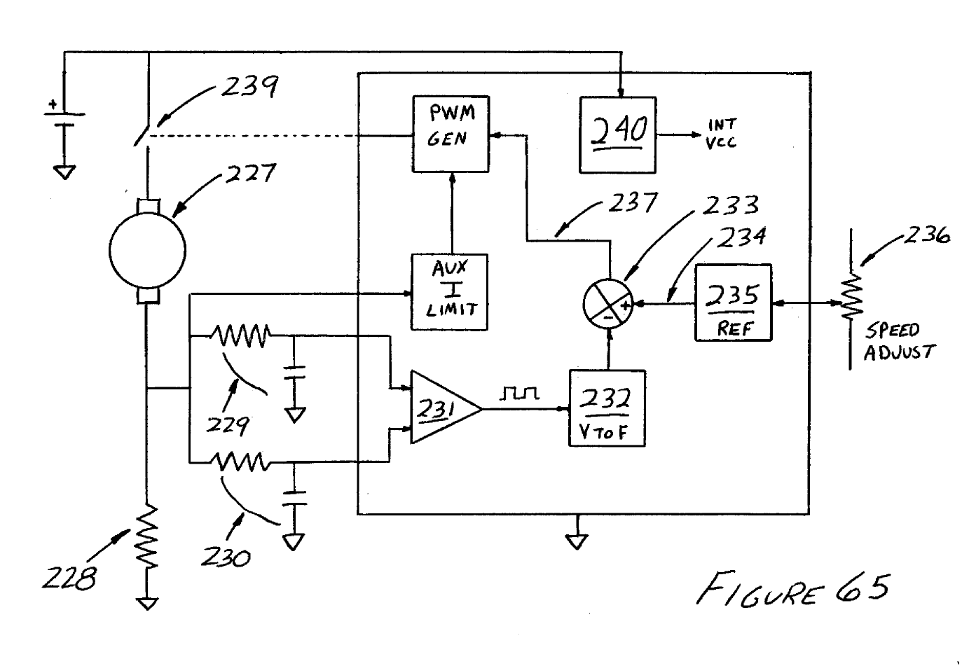

All of the active circuitry for a complete motor control circuit based on detecting commutation events as described herein could also be built into a single application specific integrated circuit (ASIC) (226), as shown in FIG. 65. In this example, the current through motor (227) is sensed with an external current sensor (228), and filtered with a pair of filters (229) and (230), which have different characteristics as described previously in this disclosure. The outputs from these filters are sensed by a commutation detector (231) that is part of the ASIC. The output of the commutation detector is fed into a frequency to voltage converter (232), whose output is subtracted (233) from a speed reference signal (234) that may either be hard-wired within the ASIC (from an internal reference (235)) or from an external source (236) such as a speed adjustment potentiometer. The result of the subtraction (237) is used to control a pulse width modulator (238), which controls a semiconductor switch (239), which controls power to the motor (227), and thus control the motor's speed. In a preferred embodiment, the ASIC would also include power conditioning circuitry (240) to provide the power to bias the internal circuitry within the ASIC from the unregulated and noisy power on the motor's terminals. Note that while the signal processing within the example ASIC is shown as analog functions, it could also be done digitally without deviating from the intention of this disclosure. The purpose of this integrated circuit would be to reduce the size and cost of a motor control circuit for DC motors, while also minimizing development time. The use of a microcontroller for this purpose was discussed previously in this disclosure; a custom integrated circuit for this purpose would allow users the benefits of a simple motor control circuit without the need to write the software required by a microcontroller. Internally, the circuitry contained within such a part would be very similar to the peripherals found in many microcontrollers; however, the logic and math functions would be hard-wired into the chip instead of being based on software.

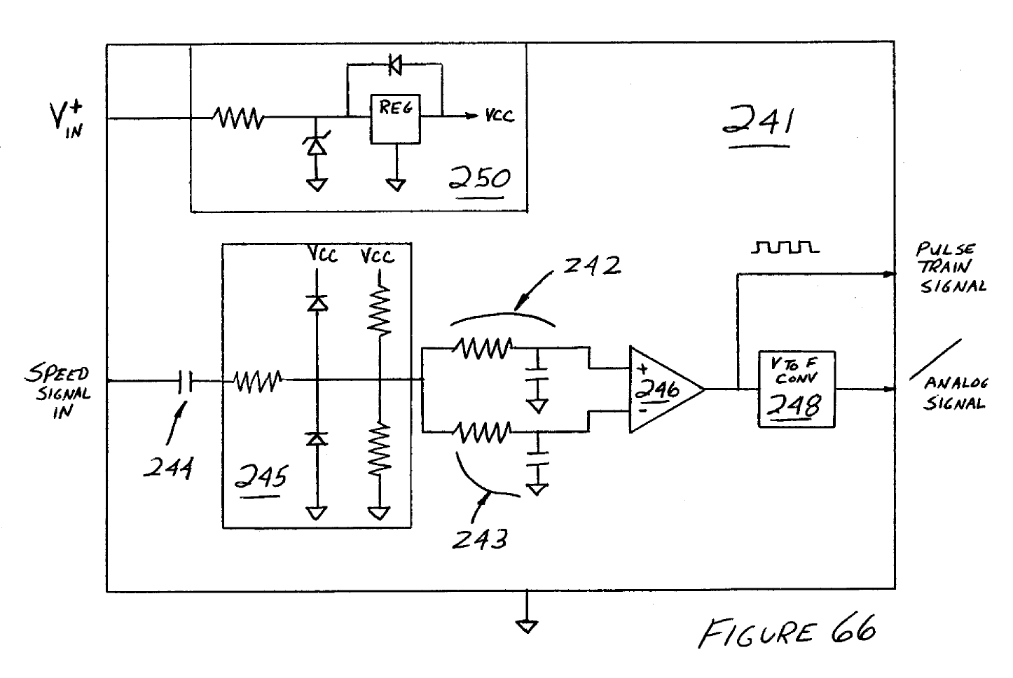

A tachometer integrated circuit (241) with even more of the needed circuitry integrated within the IC (as compared to the tachometer integrated circuit shown in FIG. 64) is shown in FIG. 66. By including the differential input filters (242) & (243) in the integrated circuit, even less external circuitry is required. By bringing AC coupling/DC blocking circuit (244) and input signal biasing circuit (245) within the integrated circuit, the circuit can now generate accurate motor speed signals for both directions of the motor. The outputs from the filters are sensed by the commutation detector (246) that is also part of the ASIC. The pulse train output (247) from the commutation detector can be made available as an output from the ASIC, and can also driver a frequency to voltage converter (248) that provides a linear output (249) that is proportional to the commutation frequency. As described previously, a linear output is ideal for driving an analog display, in this case for a simple motor speed meter. As an option, the ASIC could include an analog to digital converter, to provide a digital output. In a preferred embodiment, the ASIC would also include power conditioning circuitry (250) to provide the power to bias the internal circuitry within the ASIC from the unregulated and noisy power on the motor's terminals.

Similarly, a motor control integrated circuit (251) with even more of the circuitry integrated within the IC (than the motor control shown in FIG. 65) is shown in FIG. 67. By bringing the differential input filters (252 & (253) into the integrated circuit, even simpler supporting circuitry is required. By bringing AC coupling/DC blocking circuit (254) and input signal biasing circuit (255) within the integrated circuit, the circuit can act as a motor speed controller for both directions of the motor. The outputs from the filters are sensed by the commutation detector (256) that is also part of the ASIC. The pulse train output (257) from the commutation detector can be made available as an ancillary output from the ASIC, if desired. The pulse train output also drives a frequency to voltage converter (258) that provides a linear output (259) that is proportional to the commutation frequency. This linear output is subtracted (260) from a speed reference signal (261) to generate a speed error signal (262). The speed reference signal may be a fixed value internally stored within the ASIC or an externally generated signal that is read by the ASIC. This speed error signal is used to control a pulse width modulator (263), which controls an external semiconductor switch, which controls power to the motor, and thus control the motor's speed. In a preferred embodiment, the ASIC would also include an output amplifier (264) to generate enough current and voltage to drive the external semiconductor switch directly, without additional external circuitry. In another preferred embodiment, the ASIC would also include power conditioning circuitry (265) to provide the power to bias the internal circuitry within the ASIC from the unregulated and noisy power on the motor's terminals. Note that while the signal processing within the example ASIC is shown as analog functions, it could also be done digitally without deviating from the intention of this disclosure. The purpose of this integrated circuit would be to reduce the size and cost of a motor control circuit for DC motors, while also minimizing development time. The use of a microcontroller for this purpose was discussed previously in this disclosure; a custom integrated circuit for this purpose would allow users the benefits of a simple motor control circuit without the need to write the software required by a microcontroller. Internally, the circuitry contained within such a part would be very similar to the peripherals found in many microcontrollers; however, the logic and math functions would be hard-wired into the chip instead of being based on software.

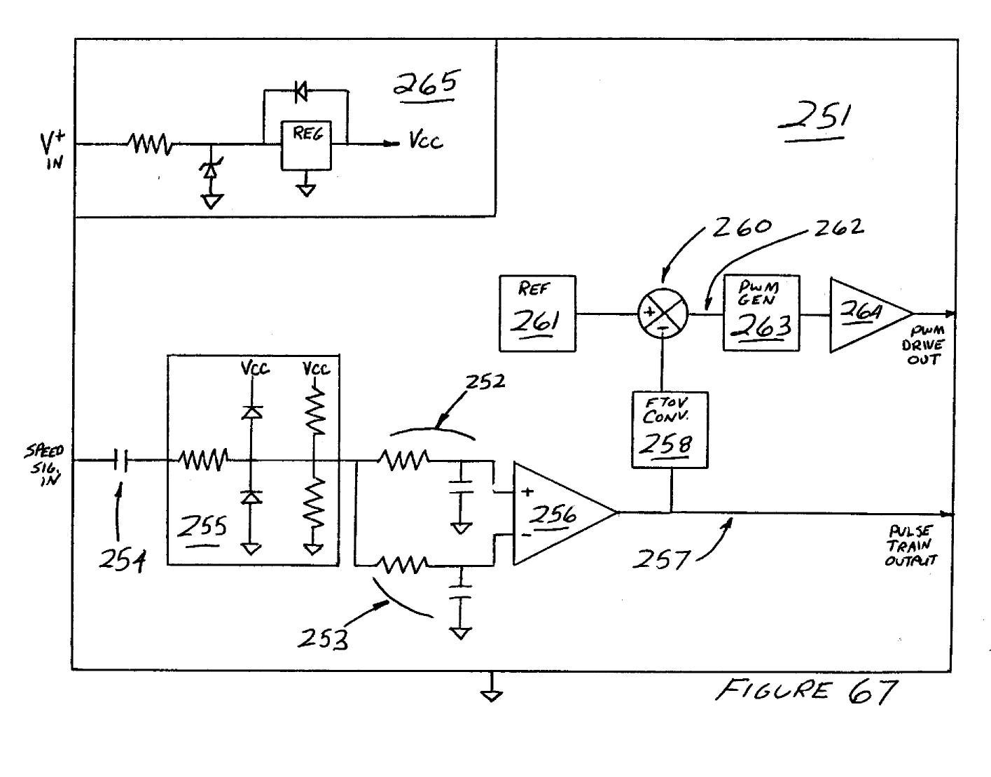

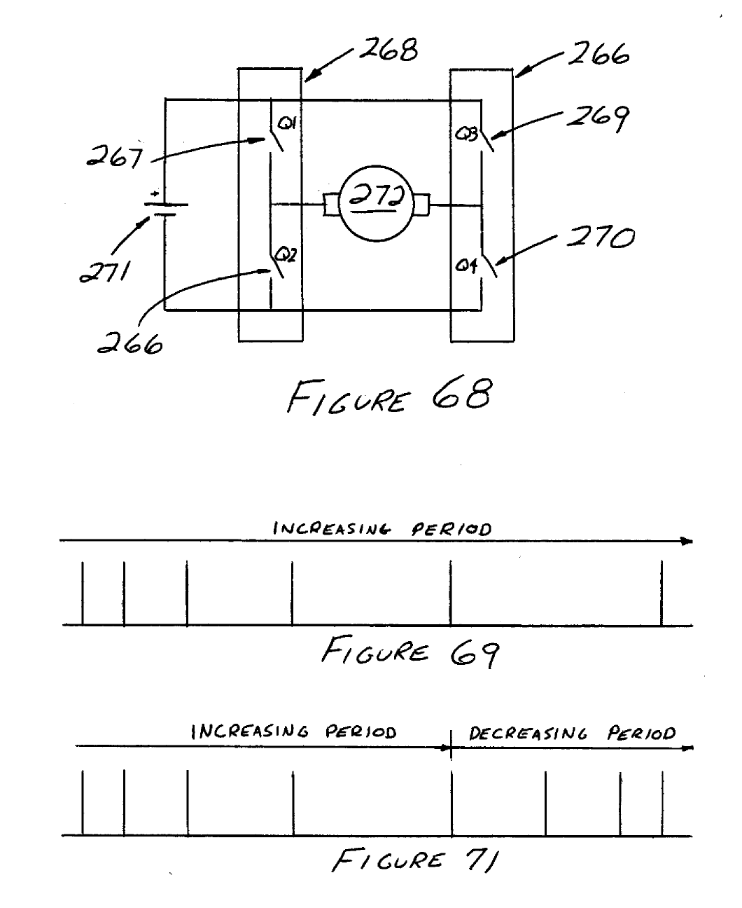

DC motors are often used in applications that require that they be reversible (such as electric drills). When reversing is required, the motor is normally driven through a reversing switch or reversing circuit, such as the full bridge (266) shown in FIG. 68. In this circuit, transistors Q1 (267) and Q4 (270) are turned on for motor rotation in one direction, while transistors Q2 (268) and Q3 (269) remain off. Following the positive current flow convention, current flows from the positive terminal of the battery (271), through Q1 (267), through the motor (272) from left to right, through Q4 (270), and back to the negative terminal of the battery (271). For operation in the opposite direction, Q2 (268) and Q3 (269) are turned on, while transistors Q1 (267) and Q4 (270) remain off . . . thus reversing the direction of current flow through the motor. Following the positive current flow convention, current flows from the positive terminal of the battery (271), through Q3 (269), through the motor (272) from right to left, through Q2 (268), and back to the negative terminal of the battery (271).

In addition to allowing motor rotation in either direction, a reversible motor drive can also be driven with a pulse-width-modulated waveform to control motor speed, as was described previously for the single-switch motor-control case. Further, it can provide braking action for the motor, allowing it to stop and to reverse directions more quickly. By reversing the drive to the motor (as described above) as the motor is still rotating, the motor will temporarily operate as a generator, converting its kinetic energy back into electrical energy which is fed back into the power source. This loss of kinetic energy is due to the slowing of the motor.

As the motor slows down during braking, the frequency of the commutation signal detected by the commutation detection circuitry will decrease. By stopping the reversed motor drive at the appropriate time, the motor can be made to stop quickly without subsequently reversing direction. One method for doing this is shown in FIG. 69. As the period of the commutation signal increases with the slowing motor, it will eventually reach a point where the motor is very nearly stopped. In order to stop the motor without reversing direction, the power to the motor should be turned off at this point. Knowing the characteristics of the motor, particularly the powered deceleration characteristics, allows a properly designed controller circuitry to turn off the drive at the appropriate time.

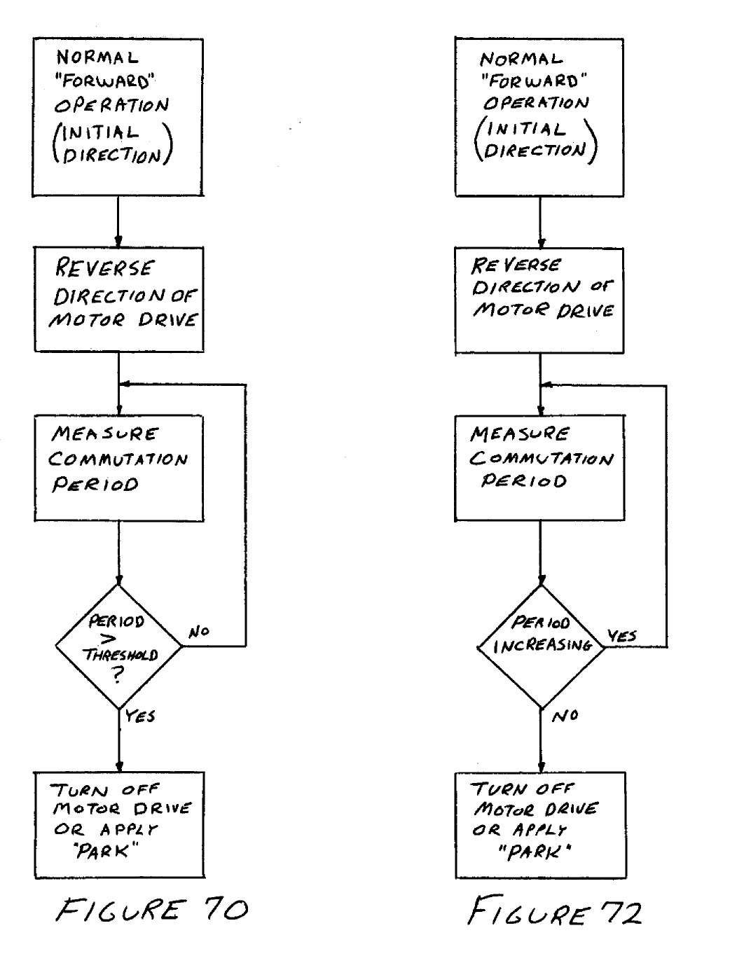

FIG. 70 shows a block diagram of one software algorithm that could be used to implement this stopping function. The motor is initially electrically powered and rotating in an initial direction (273). When the command to stop arrives, the controller reverses the polarity of the power applied to the motor (274). The controller then measures the commutation period (275) and decides (276) if it has yet slowed to some minimum period. If it has not yet slowed to this point, the controller checks again and continues to do so until the appropriate period has been reached. Once this minimum period has been detected, the controller turns off the drive to the motor (277).

A slightly different stopping method is shown in FIG. 71. Once again, the commutation detection circuitry monitors the motor speed decrease, again in the form of an increasing commutation period. Once the motor stops it will quickly reverse direction, at which point the commutation period would rapidly start to decrease. By detecting the point at which the previously increasing period suddenly starts to decrease, the point of motor reversal can be detected. By quickly turning off the reversed motor driver when this point is detected, the motor can effectively be stopped.

FIG. 72 shows a block diagram of one software algorithm that could be used to implement this stopping function. The motor is initially electrically powered and rotating in an initial direction (278). When the command to stop arrives, the controller reverses the direction of the power applied to the motor (279). The controller then measures the commutation period (280) and decides (281) if the commutation period is still increasing or if it has begun to decrease. If the period is still increasing, the controller checks again and continues to do so until a decreasing period has been detected. Once a decreasing period has been detected, the controller turns off the drive to the motor (282).

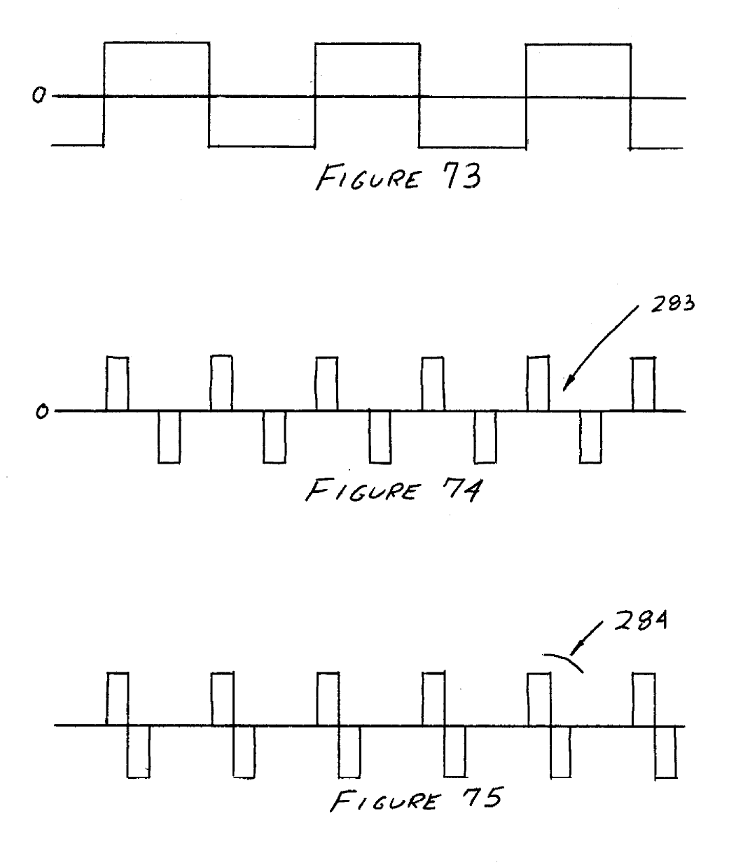

In either case, once the controller determines that the motor has stopped, the controller may optionally actuate an external (to the motor) brake to keep the motor stopped. Alternately, the controller can then begin to apply a parking signal to the motor drive. One form this parking signal may take is a continually reversing drive signal, as shown in FIG. 73. In order to reduce the power consumption and dissipation of the stopped motor, the reversing drive signal can be reduced in net duty cycle by incorporating dead-time (no drive signal applied) intervals (283), as shown in FIG. 74. In order to reverse the jitter of the motor somewhat, that dead-time can alternately be applied between pairs of back-to-back opposite drive signals (284), as shown in FIG. 75.

The examples described above use motor current as signal source for commutation events. However, the PWM and commutation rate interaction, and methods used to compensate for this interaction, are equally valid in circuits where the voltage of the motor's rotor winding or other winding is used as the source of the commutation speed signal. Further, the methods described herein are equally valid whether the fundamental shape of the current or voltage waveform, or a high-frequency ring signal, is used as the commutation signal source.

While the examples described above have used the electrical connections to the rotor of a brush & commutator motor as the source of the commutation timing signal, it is equally valid to derive those signals from the stator winding of a motor with a stator winding, or from an auxiliary winding (whose main intended purpose may or may not be the derivation of the commutation timing signal). Because of the close proximity of the numerous windings that may be present in a motor and the magnetic circuit that is present in that motor, some degree of transformer action will be present between these windings. This transformer action will couple some part of the commutation signal into these other windings. With proper filtering, signal processing, and analysis, the commutation timing signal can thus also be derived from these other windings.

While numerous embodiments for methods of detecting and using the speed and position dependent signals present on the brush/rotor terminals or other terminals of a motor or generator are presented, it will be apparent to those skilled in the art that other methods for detecting and using these signals are possible. Alternate methods not described directly herein do not deviate from the spirit or intent of this invention, and as such should be considered part of this invention. The embodiments described herein are intended to illustrate the present invention but not to limit the present invention to the specific embodiments. Accordingly, various modifications and changes may be made without departing from the spirit and scope of the present invention as described in the following claims.

I claim:

1. Sensing the speed or counting the revolutions of a DC (brush and commutator) motor by monitoring one or more signals or waveforms present at the motor's terminals.

2. The motor speed sensing or revolution counting of claim 1, where the source of the signal(s) or waveform(s) at the motor terminals is the commutation that occurs at the motor's brushes and commutator.

3. The motor speed sensing or revolution counting of claim 2, where the signal(s) or waveform(s) are detected at the motor terminals connected to the motor's brushes.

4. The motor speed sensing or revolution counting of claim 2, where the signal(s) or waveform(s) are detected at the motor terminals connected to the motor's stationary windings.

5. The motor speed sensing or revolution counting of claim 2, where at least one of the signal(s) or waveform(s) is a periodic variation in voltage.

6. The motor speed sensing or revolution counting of claim 2, where at least one of the signal(s) or waveform(s) is a periodic variation in current.

7. The motor speed sensing or revolution counting of claim 2, where at least one of the signal(s) or waveform(s) is a high frequency ringing that occurs when one or more of the motor's brushes begins or completes its contact with one or more of the commutator's conductor bars.

8. The speed sensing or revolution counting of claim 2, where the motor is a permanent magnet DC motor.

9. The speed sensing or revolution counting of claim 2, where the motor is a series wound or “universal” DC motor.

10. The speed sensing or revolution counting of claim 2, where the motor is a shunt wound DC motor.

11. The speed sensing or revolution counting of claim 2, where the motor is a compound wound DC motor.

12. The speed sensing or revolution counting of claim 2, where one or more of the sensed signal(s) or waveform(s) is a periodic signal with a frequency that corresponds to the rotation rate of the motor.

13. The speed sensing or revolution counting of claim 12 where the frequency of at least one of the sensed signal(s) or waveform(s) is the commutation frequency of the motor.

14. A circuit to sense the speed or count the revolutions of a DC (brush and commutator) motor by detecting one or more of the signals or waveforms present on the motor's terminals.

15. The circuit of claim 14 where the sensed signal(s) or waveform(s) is a periodic variation in voltage due to the commutation of the motor.

16. The circuit of claim 14 where the sensed signal(s) or waveform(s) is a variation in current due to the commutation of the motor.

17. The circuit of claim 14 where the signal(s) or waveform(s) is a high frequency ringing that occurs when one or more of the motor's brushes begins or completes its contact with one or more of the commutator's conductor bars.

18. The circuit of claim 14 where a detector circuit is used to detect the presence of the periodic signal(s) or waveform(s).

19. The circuit of claim 18 where the detector circuit uses a comparator.

20. The circuit of claim 18 where the detector circuit is used to create pulses at the same frequency as the motor's commutation rate.

21. The circuit of claim 18 where the mean or average value of the incoming signal(s) or waveform(s) is used as a reference value for the detector.

22. The circuit of claim 18 where the detector circuit is part of a programmable circuit element.

23. The circuit of claim 22 where the programmable circuit element is a microcontroller.

24. The circuit of claim 18 where the detector circuit is part of an application specific integrated circuit (ASIC).

25. The circuit of claim 18 where the signal(s) or waveform(s) passes through one or more filter(s) prior to passing to the detector.

26. The circuit of claim 25 where at least one of the filters is a passive filter.

27. The circuit of claim 25 where at least one of the filters is an active filter.

28. The circuit of claim 25 where the signal(s) or waveform(s) pass through two or more parallel filter circuits.

29. The circuit of claim 28 where the parallel filters have different frequency response characteristics.

30. The circuit of claim 14 including further circuitry to drive analog and/or digital indicators that indicate the motor's speed and/or accumulated revolutions.

31. The circuit of claim 14 including further circuitry and/or software to control and/or regulate the speed and/or torque and/or power of the motor.

32. The circuit of claim 31 where pulse-width-modulation is used to control the motor speed and/or torque and/or power of the motor.

33. The circuit of claim 31 where the circuitry and/or software forms a closed loop control.

34. The circuit of claim 31 where the regulated motor speed and/or torque and/or power is a constant or nearly constant value.

35. The circuit of claim 31 where the regulated parameter is a function of motor speed and/or torque and/or power.

36. The circuit of claim 31 where the motor speed and/or torque and/or power is adjustable via an input signal to the circuit.

37. The circuit of claim 36 where the input signal is a user adjustable input.

38. The circuit of claim 14 with a current sensing resistor that is used to sense motor current.

39. The circuit of claim 14 with a current transformer that is used to sense motor current.

40. The circuit of claim 14 with a hall-effect based current sensor that is used to sense motor current.

41. The circuit of claim 14 including circuitry to block the DC component and pass the AC component of the sensed signal.

42. The circuit of claim 14 including de-bouncing components and/or software to prevent multiple counts for single commutation events.

43. The circuit of claim 14 including circuitry and/or software to fill in missing commutation pulse events.

44. The circuit of claim 14 including circuitry to measure the counter-emf produced by the motor.

45. The circuit of claim 44 where the measured motor counter-emf is used as a rough measurement of motor speed.

46. The circuit of claim 14 including an intelligent and/or programmable circuit element.

47. The circuit of claim 45 where the intelligent and/or programmable circuit element is a microcontroller.

48. The circuit of claim 46 with user inputs that are read by the intelligent circuit element.

49. The circuit of claim 32 where circuitry and/or software is used to separate the PWM motor drive signal(s) from the commutation signal(s).

50. The circuit of claim 32 where the motor's commutation frequency is higher than the pwm frequency.

51. The circuit of claim 32 where the motor's commutation frequency is equal to the pwm frequency.

52. The circuit of claim 32 where the motor's commutation frequency is less than the pwm frequency.

53. The circuit of claim 14 including blanking circuitry and/or software to help isolate the commutation signal from other signal(s) and/or noise that may be present.

54. The circuit of claim 14 including a commutation signal detector with an adjustable detection threshold.

55. The circuit of claim 14 including an adjustable gain amplifier to change the signal amplitude.

56. The circuit of claim 14 including an automatic gain control circuit and/or software.

57. The circuit of claim 14 including passive and/or active filters to help distinguish commutation signals from PWM signals, noise signals, and other signals that may be present.

58. The circuit of claim 14 including a phase-locked-loop to help distinguish commutation signals from PWM signals, noise signals, and other signals that may be present.

59. The circuit of claim 14 where some or all of the circuitry is contained within the housing of the motor.

60. An integrated circuit containing some or all of the circuitry needed to detect commutation rated speed and/or rotation signals from a motor.

61. The integrated circuit of claim 60 containing some or all of the circuitry to produce an output signal that is a function of motor speed.

62. The integrated circuit of claim 60 containing some or all of the circuitry to control the speed and/or torque and/or power of the motor.

63. The circuit of claim 14 including circuitry and/or software to detect when the motor has come to a stop.

64. The circuit of claim 63 including circuitry and/or software to remove the motor drive signal and/or output a braking signal when motor stop has occurred.

65. The circuit of claim 31 including a circuitry and/or software to implement a soft-start function.
